(19) United States
(12) Patent Application Publication
(10) Pub. No.: US 2007/0280116 A1
(43) Pub. Date: Dec. 6, 2007

(54) ADAPTIVE MULTI-USER MIMO NON-COOPERATIVE THRESHOLD-BASED WIRELESS COMMUNICATION SYSTEM USING LIMITED CHANNEL FEEDBACK

(75) Inventors: Cheng Wang, Kowloon (HK); Ross Murch, Kowloon (HK)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: HONG KONG UNIVERSITY OF SCIENCE AND TECHNOLOGY, Kowloon (HK)

(21) Appl. No.: 11/755,179

(22) Filed: May 30, 2007

Related U.S. Application Data
(60) Provisional application No. 60/810,644, filed on Jun. 5, 2006.

(51) Int. Cl. H04L 12/26; H04Q 7/00

(52) U.S. Cl. 370/236; 370/329

(57) ABSTRACT

A system and methodology for efficient multi-user transmission in a wireless communication with limited feedback are provided. A non-cooperative feedback-based multi-user transmission scheme is described, wherein users in a wireless communication system may independently communicate selected channel information feedback to the base station. The base station may then choose suitable precoding weights based on the received channel information feedback. An adaptive threshold-based feedback approach is also described for multi-user transmission, wherein the quality of feedback for each user can be quantified by a special threshold by the system prior to engaging in multi-user communication.

### CROSS REFERENCE

This application claims the benefit of U.S. Provisional Application Ser. No. 60/810,644, filed Jun. 5, 2006, entitled “ADAPTIVE MULTI-USER MIMO NON-COOPERATIVE THRESHOLD BASED WIRELESS COMMUNICATION SYSTEM USING LIMITED CHANNEL FEEDBACK,” the entirety of which is incorporated herein by reference.

### TECHNICAL FIELD

The subject invention relates generally to wireless communications systems, and more particularly to techniques for beamforming and user scheduling in a wireless communication system.

### BACKGROUND OF THE INVENTION

In recent years, multiple-input multiple-output (MIMO) communication systems have gained considerable attention because of their promising ability to improve system capacity without the need for additional spectrum or power. Multi-user transmission techniques can be utilized to further improve the downlink capacity of MIMO systems, wherein several users may be served simultaneously in frequency and time. Much higher system capacity can be achieved by a system that utilizes such multi-user transmission techniques compared to a system that uses only single-user transmission techniques when the number of receive antennas employed by users in the system is restricted due to factors such as space limitations.

Multi-user transmission techniques require accurate channel state information at the transmitter (CSIT) such that appropriate signal processing can be performed for individual users in the space domain. However, in practice, CSIT cannot be perfectly known at a base station (BS) due to feedback channel capacity limitations present in wireless communication systems that employ frequency division duplexing (FDD). Thus, a practical feedback method is required to allow the base station to obtain CSIT corresponding to the users in communication with the base station such that multi-user transmission can be performed for those users.

Previous approaches to the limited feedback problem have primarily focused on single-user point-to-point communication. Many of the previous approaches suggest that it is desirable to design a transmit signal at the receiver rather than at the transmitter, i.e., to quantize the optimal transmit precoding matrix rather than the channel itself. In these previous approaches, a codebook that contains several precoding matrices is made known to both the transmitter and the receiver. The receiver can then select one of the codewords according to particular criteria and send back the index of the codeword to the transmitter. However, approaches that focus on single-user transmission do not sufficiently extend to multi-user transmission because of the differences and intricacies created by the presence of inter-user interference in multi-user transmission.

Other previous approaches to the limited feedback problem exist for multi-user transmission, but these approaches suffer from a lack of efficiency. In one such approach, a random beamforming scheme is used for transmission in a multi-user multiple-input single-output (MU-MISO) system. However, because the performance of this approach largely depends on the number of active users in the system, the performance of the approach is very poor when the number of users is comparable to the number of transmit antennas. In another such approach, random vector quantization (RVQ) is used in a MU-MISO system. The capacity degradation due to limited feedback and the required feedback load per user can then be analyzed as a function of the number of transmit antennas and the system signal-to-noise ratio (SNR). However, this approach also results in inefficient performance in many cases.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention provides a system and methodology for efficient MU-MISO transmission in a wireless communication system with limited feedback. A realistic scheme for efficient multi-user transmission is provided, wherein users independently communicate selected channel information feedback to the base station. The base station may then choose suitable precoding weights based on the received channel information feedback from the users. In addition, an adaptive threshold-based feedback approach is also provided, wherein the quality of feedback for each user can be quantified by a special threshold by the system prior to engaging in multi-user communication. By employing the provided approaches for multi-user transmission, the capacity of a wireless communication system can be significantly improved over that of previous approaches.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a wireless communication system in accordance with an aspect of the present invention.

FIG. 2 is a block diagram of an exemplary wireless communication system in accordance with an aspect of the present invention.

FIG. 3 is a block diagram of an exemplary wireless communication system in accordance with an aspect of the present invention.

FIG. 4 illustrates performance data for a communication system utilizing cooperative feedback-based multi-user transmission and a system utilizing single-user transmission.

FIG. 5 illustrates a comparison between the performance of a communication system utilizing a random vector quantization codebook and the performance of an exemplary system utilizing a non-cooperative codebook in accordance with an aspect of the present invention.

FIG. 6 illustrates a comparison between the performance of an exemplary communication system utilizing non-cooperative feedback-based multi-user transmission in accordance with an aspect of the present invention and the performance of a system utilizing single-user transmission.

FIG. 7 illustrates a comparison between the performance of an exemplary communication system utilizing non-cooperative feedback-based multi-user transmission in accordance with an aspect of the present invention and the performance of a system utilizing single-user transmission.

FIG. 8 illustrates performance data for an exemplary wireless communication system in accordance with an aspect of the present invention.

FIG. 9 illustrates performance data for an exemplary wireless communication system in accordance with an aspect of the present invention.

FIG. 10 illustrates a comparison between the performance of an exemplary communication system utilizing adaptive non-cooperative feedback-based multi-user transmission in accordance with an aspect of the present invention and the performance of a system utilizing single-user transmission.

FIG. 11 illustrates a comparison between the performance of an exemplary communication system utilizing non-cooperative feedback-based multi-user transmission and the performance of an exemplary communication system utilizing adaptive non-cooperative feedback-based multi-user transmission in accordance with an aspect of the present invention.

FIG. 12 is a flowchart of a method of non-cooperative feedback-based multi-user transmission in a wireless communication system in accordance with an aspect of the present invention.

FIG. 13 is a flowchart of a method of adaptive non-cooperative feedback-based multi-user transmission in a wireless communication system in accordance with an aspect of the present invention.

FIG. 14 is a flowchart of a method of adaptive non-cooperative feedback-based multi-user transmission in a wireless communication system in accordance with an aspect of the present invention.

FIG. 15 is a block diagram representing an exemplary non-limiting computing system or operating environment in which the present invention may be implemented.

FIG. 16A illustrates an overview of a network environment suitable for service by embodiments of the present invention.

FIG. 16B illustrates a GPRS network architecture that may incorporate various aspects of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The components may communicate via local and/or remote processes such as in accordance with a signal having one or more data packets (e.g., data from one component interacting with another component in a local system, distributed system, and/or across a network such as the Internet with other systems via the signal).

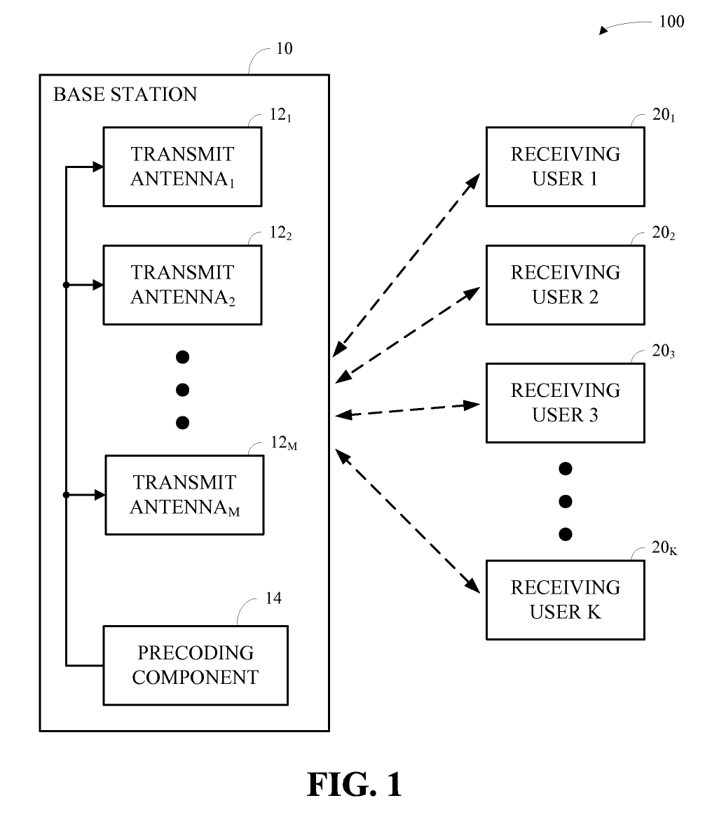

Referring to FIG. 1, a high-level block diagram of a wireless communication system 100 in accordance with an aspect of the present invention is illustrated. In one example, system 100 is a narrow-band MU-MISO system with a base station (10) that communicates with K receiving users 20 on a downlink. While only one base station 10 is illustrated in system 100, it is to be appreciated that system 100 can contain any number of base stations 10 and/or receiving users 20. Base station 10 may further be equipped with M transmit antennas for downlink communication with users 20, each of which may have a single receive antenna (not shown).

In accordance with one aspect, base station 10 further includes a precoding component 14 that can coordinate multi-user transmission to the receiving users 20. In one example, precoding component 14 can pass a transmit data symbol corresponding to each receiving user 20, which may be expressed as bₖ, k=1, . . . ,K, through a beamforming weight corresponding to each respective receiving user 20, which may be expressed as wₖ, k=1, . . . ,K. Each symbol may then be communicated to the transmit antennas 12 for transmission to the respective users 20 via a downlink channel.

Once the transmit data symbols are transmitted by the base station 10, the received signal at the k^{th} user 20 may be expressed as the following:

$${y}_{k} = {h}_{k} {\sum }_{i = 1}^{K} {w}_{i} {b}_{i} + {n}_{k} , k = 1 , … , K , \qquad ( 1 )$$

where hₖ=∥hₖ∥vₖ^{H} is a 1×M quasi-static channel vector corresponding to the k^{th} user 20 with zero-mean, unit-variance, and independent and identically distributed (i.i.d) complex Gaussian entries and ^{H} represents the Hermitian operation. Further, as used in the channel vector, ∥hₖ∥=\sqrt{hₖhₖ^{H}} is the channel gain, vₖ represents the direction of the channel and nₖ represents zero-mean additive white Gaussian noise with unity variance. Based on the above, the sum mutual information of the system 100 in the downlink can then be expressed as follows:

$$I = {\sum }_{k = 1}^{K} {I}_{k} , \qquad ( 2 )$$

where the mutual information of user k is given by

$${I}_{k} = {log}_{2} ( 1 + {h}_{k} {w}_{k} {w}_{k}^{H} {h}_{k}^{H} / ( 1 + {h}_{k} {\sum }_{i = 1 , i \neq k}^{K} {w}_{i} {w}_{i}^{H} {h}_{k}^{H} ) ) . \qquad ( 3 )$$

In one example, K≦M is the largest number of users 20 that can be simultaneously served by the base station 10. Alternatively, the number of users 20 in system 100 may be larger than K, and other multiple access techniques may be used to serve each of the users 20.

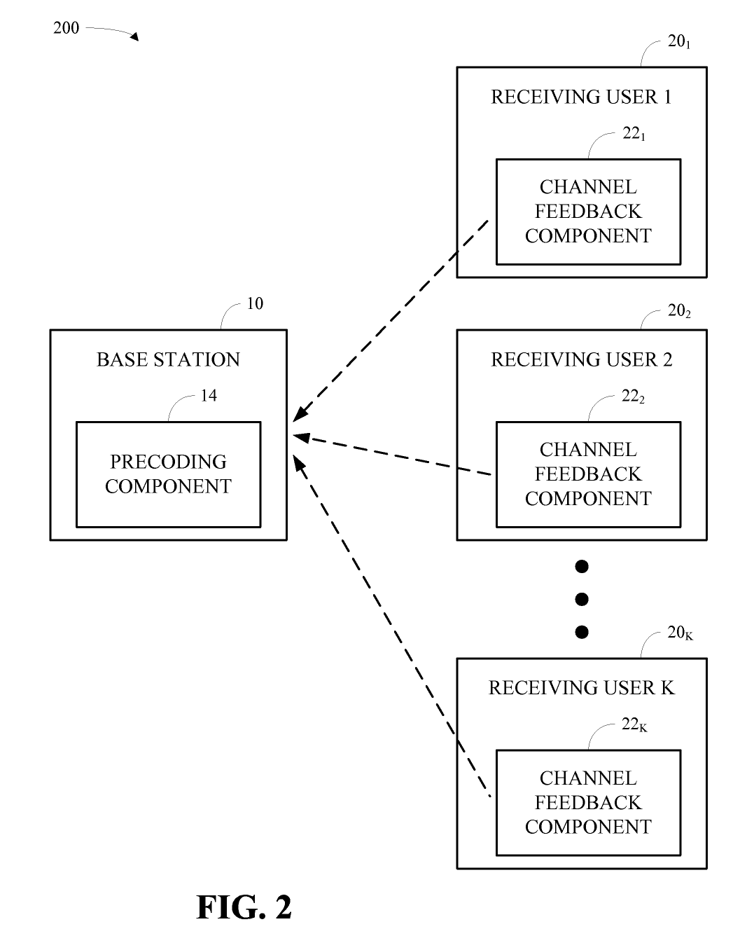

Referring now to FIG. 2, an exemplary wireless communication system 200 in accordance with an aspect of the present invention is illustrated. In one example, system 200 can include a base station 10 that may utilize a precoding component 14 to facilitate multi-user downlink transmission. Further, system 200 can include K receiving users 20, each of which may include a channel feedback component 22 for providing CSI feedback to the base station 10.

In accordance with one aspect, system 200 may utilize frequency division duplexing (FDD) for downlink transmission from the base station 10 to the users 20. However, uplink channels and downlink channels are not reciprocal in a system utilizing FDD due to the frequency separation between them. Thus, feedback provided by a channel feedback component 22 at each user 20 may be needed by the base station 10 to allow the downlink broadcast channel(s) to be known. In accordance with another aspect, to maximize the capacity of system 200, the precoding matrix wₖ for each user 20 would ideally be a continuous function of the channels h₁, . . . ,h_{K} utilized by all users 20. However, in practice, each user 20 may have no knowledge of the channels experienced by the other users 20. Thus, the users 20 in the system 200 may not be able to cooperate to jointly decode transmitted data or to jointly provide downlink CSI feedback. In one example, precoding component 14 can mitigate these problems by utilizing approaches for beamforming that are based on independent feedback from the users 20.

As noted above, each user 20 in system 200 may have no knowledge of the channels experienced by other users 20. Additionally, due to the presence of inter-user interference, it may be difficult for one user 20 to choose a suitable beamforming vector based solely on its own channel. Thus, in one example of the present invention, the system 200 can employ non-cooperative feedback-based multi-user transmission. More particularly, instead of selecting an appropriate beamforming weight at each user 20, the channel feedback component 22 at each user 20 can send selected channel information to the base station 10. Based on this channel information, the preceding component 14 at the base station 10 can jointly select beamforming weights for all users 20. In accordance with one aspect, each channel feedback component 22 can select information that may be useful to the base station 10 to handle inter-user interference.

In accordance with one aspect, the single-user channel space can be partitioned into Q regions ={ ⁰, . . . , ^{Q-1}} along with Q partition centroids ~={F⁰, . . . ,F^{Q-1}} according to a predetermined objective, where N=log₂ Q is the number of bits that is allotted to each user 20 for channel information feedback. In one example of the present invention, the regions and partition centroids utilized by system 200 may be fixed at the time of algorithm development. Further, the partitions may be stored by each channel feedback component 22 at each user 20 as well as by the base station 10. It should be appreciated that, as used in the preceding expressions and generally herein, numbers displayed in superscript refer to region indices and numbers displayed in subscript refer to user indices. Based on the above partition, each user 20 may independently determine which region its channel belongs to based on a predetermined criterion. The channel feedback component 22 at each respective user 20 may then send back the index of the determined region to the base station 10. The precoding component 14 at the base station 10 may then select an appropriate transmit precoding weight for each user based on the feedback information from each of the users 20. By way of non-limiting example, a general problem formulation may be defined as follows:

$${max}_{{\tilde{H} = \{ {H}^{0} , {H}^{1} , … , {H}^{Q - 1} \}}_{{{H}_{k} = g ( {h}_{k} ) , {H}_{k} ∈ \tilde{H} , k = 1 , … , K}_{{w}_{k} = f ( {H}_{1} , … , {H}_{K} ) , k = 1 , … , K}}} E [ {\sum }_{k = 1}^{K} {I}_{k} ] , such that {\sum }_{k = 1}^{K} tr ( {w}_{k} {w}_{k}^{H} ) \leq {P}_{T} , \qquad ( 4 )$$

where tr(•) represents the matrix trace operation. In accordance with one aspect, the sum ergodic mutual information may be used as a performance measure of system 200, as it quantifies the total data flow that the system 200 can support in the downlink. In one specific, non-limiting example, the precoding component 14 can select precoding weights for each user 20 under an assumption that the channel estimates at each user 20 are perfect and that each feedback channel in the system 200 is error-free and delay-free in order to simplify the operation of the precoding component 14 and analysis thereof.

In one example of the present invention, the preceding component 14 can select beamforming weights for each of K users 20 by maintaining and employing a K-dimensional beamforming weight table. The beamforming weight table may include, for example, beamforming weights to be used corresponding to each user 20 and each possible feedback index that may be received from each respective user 20. The feedback indices from each user 20 may be generated by a channel feedback component 22 at each user 20 and can represent, for example, a region of the single-user channel space that the channel experienced by each respective user 20 belongs to. By way of non-limiting example, if system 200 has two users 20, a two-dimensional beamforming weight table can be available at the base station 10, which may be constructed in a similar manner to Table 1 as follows:

TABLE 1
Two-dimensional beamforming weight table.

| | g(h₂) | | | |
|---|---|---|---|---|
| g(h₁) | 0 | 1 | . . . | Q − 1 |
| 0 | w₁^{0,0},w₂^{0,0} | w₁^{0,1},w₂^{0,1} | . . . | w₁^{0,Q-1},w₂^{0,Q-1} |
| 1 | w₁^{1,0},w₂^{1,0} | w₁^{1,1},w₂^{1,1} | . . . | w₁^{1,Q-1},w₂^{1,Q-1} |
| . | . | . | . | . |
| . | . | . | . | . |
| . | . | . | . | . |
| Q − 1 | w₁^{Q-1,0},w₂^{Q-1,0} | w₁^{Q-1,1},w₂^{Q-1,1} | . . . | w₁^{Q-1,Q-1},w₂^{Q-1,Q-1} |

Based on the two-dimensional beamforming weight table, the preceding component 14 may then choose an appropriate beamforming weight set [w₁, w₂] from the table based on the feedback indices sent back by both users 20. More particularly, if i, j are the indices respectively sent back by the first and second users 20, then the beamforming weight set corresponding to the (i, j)^{th} entry of the two-dimensional beamforming weight table may be selected by the preceding component 14 for downlink transmission.

By way of specific, non-limiting example, each channel feedback component 22 in the system 200 may select useful information for beamforming to send back to the base station 10 as follows. The selection performed by each channel feedback component 22 and the beamforming performed by the preceding component 14 may represent the multi-user downlink transmission scheme of the system 200 as a MU-MIMO decomposition scheme. Although this scheme is sub-optimal, it may nonetheless be used to maximize efficiency and minimize required complexity. In such a scheme, data for each user 20 is transmitted in the joint null-space of the channels of all other users 20 in the system 200, such that wₖ ε _{i≠k} (hᵢ). Thus, each user 20 will not experience any interference from other users 20 when the CSI at the base station 10 is perfect. The orthonormal basis of the joint null-space V̅ₖ can then be found by singular value decomposition as follows:

$$\begin{matrix}{h}_{\overline{k}} = {[ \begin{matrix}{h}_{1}^{H} & ⋯ & {h}_{k - 1}^{H} & {h}_{k + 1}^{H} & ⋯ & {h}_{K}^{H}\end{matrix} ]}^{H} \\ = [ \begin{matrix}{\tilde{U}}_{k} & {\overline{U}}_{k}\end{matrix} ] [ \begin{matrix}{Σ}_{k} & 0 \\ 0 & 0\end{matrix} ] [ \begin{matrix}{\tilde{V}}_{k}^{H} \\ {\overline{V}}_{k}^{H}\end{matrix} ]\end{matrix} \qquad ( 5 )$$

The beamforming vector for each user 20 wₖ, k=1, . . . ,K may then be defined as a linear combination of the columns of V̅ₖ, which may be represented as

$${w}_{k} = \sqrt{{P}_{k}} {\overline{V}}_{k} {f}_{k} with ‖ {f}_{k} ‖ = 1 , {\sum }_{k = 1}^{K} {P}_{k} = {P}_{T} .$$

Based on these definitions, a received signal at a k^{th} user 20 can be expressed as follows:

yₖ=\sqrt{Pₖ}∥hₖ∥vₖ^{H} V̅ₖfₖbₖ+nₖ. (6)

Based on the MU-MIMO decomposition scheme, an assumption may be made for the purposes of computation that no inter-user interference is experienced by the users 20 in the system 200. Thus, maximizing the mutual information in the system 200 is equivalent to maximizing the SNR of the system 200. To maximize the SNR 200 of the system, fₖ can be defined as follows:

fₖ= V̅ₖ^{H}vₖ/∥ V̅ₖ^{H}vₖ∥, k=1, . . . ,K, (7)

and as a consequence, the beamforming vector of each user can be written as follows:

wₖ=\sqrt{Pₖ} V̅ₖ V̅ₖ^{H}vₖ/∥ V̅ₖ^{H}vₖ∥, k1, . . . ,K. (8)

Thus, in this example, the precoding component 14 at the base station 10 may require knowledge of V̅ₖ to null inter-user interference in the system 200. Based on the vector hₖ=∥hₖ∥vₖ^{H}, hₖ⁻ may then be re-expressed as:

hₖ⁻=diag(∥h₁∥ . . . ∥hₖ₋₁∥ ∥hₖ₊₁∥ . . . ∥h_{K}∥)vₖ⁻, (9)

where diag (x) is a diagonal matrix with vector x on the main diagonal, and vₖ⁻=[v₁ . . . vₖ₋₁ vₖ₊₁ . . . v_{K}]^{H}. Based on the above definitions, it should be appreciated that the matrices hₖ⁻ and vₖ⁻ have the same null-space. As a result, vₖ, k=1, . . . ,K may be chosen as the most useful information that can be sent by the channel feedback components 22 to the base station 10 in order to null inter-user interference. Additionally, channel gain information may also be sent by the channel feedback components 22 to the base station 10 to facilitate power allocation among users 20. However, it should be appreciated that downlink transmission may be conducted in the system 200 without knowledge of channel gain at the base station 10. In such an example, the base station 10 may allocate power equally among all users 20, such that Pₖ=P_{T}/K, k=1, . . . ,K.

In accordance with one aspect, each channel feedback component 22 may be limited in the amount of feedback bits it can send back to the base station 10 in a feedback channel. When the feedback channel has no capacity constraint, perfect knowledge of vₖ, k=1, . . . ,K can be made available to the base station 10 and inter-user interference can be canceled perfectly. However, when the feedback channel has a limited capacity, only a quantized version of vₖ, k=1, . . . ,K may be available. This quantized information may be expressed as \hat{v}ₖ,k=1, . . . ,K. \hat{v}ₖ⁻ may then be defined such that \hat{v}ₖ⁻=[\hat{v}₁ . . . \hat{v}ₖ₋₁ \hat{v}ₖ₊₁ . . . \hat{v}_{K}]^{H}. Further,

$${\hat{\tilde{V}}}_{k}$$

may be defined as an orthonormal basis of the row space of \hat{v}ₖ⁻ and

$${\hat{\overline{V}}}_{k}$$

as an orthonormal basis of the null-space of \hat{v}ₖ⁻ such that

$$[ {\hat{\tilde{V}}}_{k} , {\hat{\overline{V}}}_{k} ]$$

spans C^{M}. Based on these definitions, the beamforming weights may be expressed as follows:

$${\hat{w}}_{k} = \sqrt{{P}_{T} / K} {\hat{\overline{V}}}_{k} {\hat{\overline{V}}}_{k}^{H} {\hat{v}}_{k} / ‖ {\hat{\overline{V}}}_{k}^{H} {\hat{v}}_{k} ‖ , k = 1 , … , K . \qquad ( 10 )$$

As a consequence of the limited feedback capacity, inter-user interference may not be capable of being perfectly eliminated in the system 200. Thus, residual inter-user interference may exist, which may in turn cause system performance degradation in terms of mutual information. In order to minimize this degradation, the codebook and/or feedback strategy employed by the system 200 may be designed to minimize the residual inter-user interference caused by the limited feedback capacity of the system 200.

By way of specific, non-limiting example, the channel partitions ={ ⁰, . . . , ^{Q-1}} and corresponding centroids {v⁰,v¹, . . . ,v^{Q 1}} employed by system 200 may be designed based on the following. From Equation (10), the residual inter-user interference for the k^{th} user can be expressed as:

$$\frac{{P}_{T}}{K} {\sum }_{i = 1 , i \neq k}^{K} \frac{{\hat{v}}_{i}^{H} {\hat{\overline{V}}}_{i} {\hat{\overline{V}}}_{i}^{H} {h}_{k}^{H} {h}_{k} {\hat{\overline{V}}}_{i} {\hat{\overline{V}}}_{i}^{H} {\hat{v}}_{i}}{{\hat{v}}_{i}^{H} {\hat{\overline{V}}}_{i} {\hat{\overline{V}}}_{i}^{H} {\hat{v}}_{i}} , k = 1 , … , K . \qquad ( 11 )$$

### It should be appreciated that

$${\hat{\overline{V}}}_{i} , i \neq k ,$$

is a function of \hat{v}ₖ, and as a result the criterion for choosing \hat{v}ₖ can be expressed as follows:

$${min}_{{\hat{v}}_{k} \{ {v}^{0} , {v}^{1} , … , {v}^{Q - 1} \}} {\sum }_{i = 1 , i \neq k}^{K} \frac{{\hat{v}}_{i}^{H} {\hat{\overline{V}}}_{i} {\hat{\overline{V}}}_{i}^{H} {h}_{k}^{H} {h}_{k} {\hat{\overline{V}}}_{i} {\hat{\overline{V}}}_{i}^{H} {\hat{v}}_{i}}{{\hat{v}}_{i}^{H} {\hat{\overline{V}}}_{i} {\hat{\overline{V}}}_{i}^{H} {\hat{v}}_{i}} . \qquad ( 12 )$$

However, since \hat{v}ᵢ, i≠k, may not be known to the k^{th} user 20, the selection of \hat{v}ₖ by a user 20 cannot depend on \hat{v}ᵢ, i≠k. Thus, each user 20 can choose a \hat{v}ₖ in order to minimize the upper bound of inter-user interference. It should be appreciated that:

$$\frac{{\hat{v}}_{i}^{H} {\hat{\overline{V}}}_{i} {\hat{\overline{V}}}_{i}^{H} {h}_{k}^{H} {h}_{k} {\hat{\overline{V}}}_{i} {\hat{\overline{V}}}_{i}^{H} {\hat{v}}_{i}}{{\hat{v}}_{i}^{H} {\hat{\overline{V}}}_{i} {\hat{\overline{V}}}_{i}^{H} {\hat{v}}_{i}} \leq {h}_{k} {\hat{\overline{V}}}_{i} {\hat{\overline{V}}}_{i}^{H} {h}_{k}^{H} , i \neq k , \qquad ( 13 )$$

where the equality holds when \hat{v}ᵢ=hₖ^{H}/∥hₖ∥ or rank

$$( {\hat{\overline{V}}}_{k} ) = 1.$$

### Since

$${\hat{\tilde{V}}}_{i}$$

contains an orthonormal basis of the row space of

$${\hat{v}}_{i}^{-} , {\hat{\tilde{V}}}_{i}$$

may be chosen as

$${\hat{\tilde{V}}}_{i} = [ {\hat{v}}_{k} , {x}_{1} , … , {x}_{K - 2} ]$$

without loss of generality, where x₁, . . . ,x_{K-2} can be defined as arbitrary orthonormal vectors that are orthogonal to \hat{v}ₖ such that [\hat{v}ₖ,x₁, . . . ,x_{K-2}] spans the row-space of \hat{v}ᵢ⁻. Based on these definitions, the following equation can be derived:

$$\begin{matrix}{h}_{k} {\hat{\overline{V}}}_{i} {\hat{\overline{V}}}_{i}^{H} {h}_{k}^{H} = {h}_{k} ( I - {\hat{\tilde{V}}}_{i} {\hat{\tilde{V}}}_{i}^{H} ) {h}_{k}^{H} \\ = {h}_{k} ( I - {\hat{v}}_{k} {\hat{v}}_{k}^{H} - {x}_{1} {x}_{1}^{H} - … - {x}_{K - 2} {x}_{K - 2}^{H} ) {h}_{k}^{H} .\end{matrix} \qquad ( 14 )$$

Combining Equations (11), (13) and (14), the upper bound of the inter-user interference of the k^{th} user 20 can be expressed as a decreasing function of the following:

hₖ\hat{v}ₖ\hat{v}ₖ^{H}hₖ^{H}. (15)

As a result, the criterion utilized by each channel feedback component 22 for choosing \hat{v}ₖ may then be expressed as:

$${max}_{{\hat{v}}_{k} \{ {v}^{0} , {v}^{1} , … , {v}^{Q - 1} \}} {\sum }_{i = 1 , i \neq k}^{K} {h}_{k} {\hat{v}}_{k} {\hat{v}}_{k}^{H} {h}_{k}^{H} , . \qquad ( 16 )$$

Based on the designed feedback strategy, the codebook may be designed to maximize the ergodic correlation as follows:

$${\sum }_{q = 0}^{Q - 1} {max}_{{H}^{q} , {v}^{q}} E [ {v}^{{q}^{H}} {h}^{H} {hv}^{q} \vert h ∈ {q}^{} ] Pr ( h ∈ {q}^{} ) , such that {v}^{{q}^{H}} {v}^{q} = 1 for q = 0 , 1 , … , Q - 1. \qquad ( 17 )$$

The codebook may then be designed, for example, using an iterative two-step algorithm. First, an optimal v^{q} may be determined given a partition ^{q}, q=0, . . . ,Q−1, as:

$${v}^{q} = \text{arg} {max}_{{v}^{q}} E [ {v}^{{q}^{H}} {h}^{H} {hv}^{q} \vert h ∈ {q}^{} ] Pr ( h ∈ {q}^{} ) , such that {v}^{{q}^{H}} {v}^{q} = 1. \qquad ( 18 )$$

Next, an optimal partition ^{q} may be determined given v^{q}, q=0, . . . ,Q−1, as:

^{q}={h: v^{q}^{^{H}}h^{H}hv^{q}≧v^{j}^{^{H}}h^{H}hv^{j}, ∀jε[0, . . . ,q−1,q+1, . . . ,Q−1]}. (19)

Thus, by iteratively solving Equations (18) and (19), the optimal codebook may be obtained. It should be appreciated that the algorithm represented by Equations (18) and (19) will always converge because the correlations are increased at every step due to the updated quantities in the equations being chosen to maximize the correlation given the fixed other quantities. In one example, several random initial partitions can be taken and the resulting codebook that yields the largest ergodic correlation as expressed in Equation (17) may be selected. The codebook may additionally be set up offline and in advance and stored by each user 20 and the base station 10 such that the beamforming weight set for each entry of the beamforming weight table can be determined using the designed codebook and Equation (10).

For a given channel realization, each user 20 in the system 200 may then send back an index to the base station 10 that can be chosen according to the following:

$${q}_{k}^{*} = g ( {h}_{k} ) = \text{arg} {max}_{q = 0 , 1 , … , Q - 1} {‖ {h}_{k} {v}^{q} ‖}^{2} , k = 1 , … , K , \qquad ( 20 )$$

where \hat{v}ₖ=v^{q}^{ₖ}*. The base station 10 may then select the beamforming weight set corresponding to the (q*₁,q*₂,q*_{K})^{th} entry of the beamforming weight table.

In accordance with one aspect, the above codebook and feedback strategy design approaches employed by the system 200 may also be utilized to maximize the mutual information of a single-user transmission system. For example, a system utilizing single-user transmission can be constrained to employ beamforming and the following approximation can be used to find an optimal weight w^{q} given a certain partition ^{q}:

E[ log₂ (1+P_{T}w^{q}^{^{II}}h^{H}hw^{q})|hε ^{q}}\tilde{=}log₂(1+P_{T}w^{q}^{^{II}}E[h^{H}h ^{q}]w^{q}), (21)

Thus, the optimal partition ⁰, ¹, . . . , ^{Q-1}} derived for the system 200 would also be optimal for a single-user transmission system in the sense of maximizing the ergodic mutual information, where {\sqrt{P_{T}}v⁰,\sqrt{P_{T}}v¹, . . . ,\sqrt{P_{T}}v^{Q 1}} is the corresponding optimal codebook.

In accordance with another aspect of the present invention, the performance of system 200 with high and low SNR can be analyzed as follows. Properties of the random vector quantization (RVQ) codebook Z=[z⁰,z¹, . . . ,z^{Q-1}] may be utilized in analyzing the performance of system 200, in which each z^{q} is independently and identically chosen from the M-dimensional complex unit sphere Ω_{M} according to isotropic distribution. In one example, RVQ may be chosen to analyze system 200 because the performance of RVQ is close, although inferior, to the performance of system 200 in the sense of maximizing the ergodic correlation as defined by Equation (17), and because RVQ allows for relatively simple analysis of system 200. Thus, it should be appreciated that the performance achieved by the codebook employed by system 200 is better than that achieved by RVQ. Specifically, the following properties of RVQ may be used in the analysis of system 200. First, given arbitrary unit vectors zᵢ and zⱼ that are isotropically distributed on Ω_{M}, 1−|zᵢ^{H}zⱼ|² is beta distributed with parameters M−1 and 1, and:

Pr(\sqrt{1−|zᵢ^{H}zⱼ|²}≧ε)=1−ε^{2(M-1)}. (22)

Further, since z^{q}, q=0,1. . . ,Q−1 are independent, the following may be derived:

Pr(∥vₖ^{H}z^{q}^{ₖ}*∥²≦δ)=(1−(1−δ)^{(M-1)})^{Q}, (23)

from which it follows that:

$$E [ 1 - {\vert {v}_{k}^{H} {z}^{{q}_{k}^{*}} \vert}^{2} ] = Q \cdot B ( Q , \frac{M}{M - 1} ) \leq {2}^{- N / ( M - 1 )} , \qquad ( 24 )$$

where B(•,•) is the beta function, N=log₂ Q.

As noted above, if the feedback channel employed by each user 20 has no capacity constraint, the users 20 in the system 200 will experience no inter-user interference and, thus, the signal-plus-interference-to-noise ratio (SINR) for each user 20, SINRₖ→∝ as P_{T}→∞. On the other hand, in the case of limited feedback, the received SINR of the k^{th} user 20 can be expressed based on Equation (10) as follows:

$${SINR}_{k} = \frac{\frac{{P}_{T}}{K} \frac{{\hat{v}}_{k}^{H} {\hat{\overline{V}}}_{k} {\hat{\overline{V}}}_{k}^{H} {h}_{k}^{H} {h}_{k} {\hat{\overline{V}}}_{k} {\hat{\overline{V}}}_{k}^{H} {\hat{v}}_{k}}{{v}_{k}^{H} {V}_{k} {V}_{k}^{H} {v}_{k}}}{1 + \frac{{P}_{T}}{K} {\sum }_{i = 1 , i \neq k}^{K} \frac{{\hat{v}}_{i}^{H} {\hat{\overline{V}}}_{i} {\hat{\overline{V}}}_{i}^{H} {h}_{k}^{H} {h}_{k} {\hat{\overline{V}}}_{i} {\hat{\overline{V}}}_{i}^{H} {\hat{v}}_{i}}{{\hat{v}}_{i}^{H} {\hat{\overline{V}}}_{i} {\hat{\overline{V}}}_{i}^{H} {\hat{v}}_{i}}} , k = 1 , … , K . \qquad ( 25 )$$

### It should be appreciated from Equation (25) that as P_{T}→∞, SINRₖ is upper-bounded by αₖ/βₖ due to the presence of the residual inter-user interference, where

$${α}_{k} = \frac{{\hat{v}}_{k}^{H} {\hat{\overline{V}}}_{k} {\hat{\overline{V}}}_{k}^{H} {h}_{k}^{H} {h}_{k} {\hat{\overline{V}}}_{k} {\hat{\overline{V}}}_{k}^{H} {\hat{v}}_{k}}{{\hat{v}}_{k}^{H} {\hat{\overline{V}}}_{k} {\hat{\overline{V}}}_{k}^{H} {\hat{v}}_{k}} and {β}_{k} = {\sum }_{i = 1 , i \neq k}^{K} \frac{{\hat{v}}_{i}^{H} {\hat{\overline{V}}}_{i} {\hat{\overline{V}}}_{i}^{H} {h}_{k}^{H} {h}_{k} {\hat{\overline{V}}}_{i} {\hat{\overline{V}}}_{i}^{H} {\hat{v}}_{i}}{{\hat{v}}_{i}^{H} {\hat{\overline{V}}}_{i} {\hat{\overline{V}}}_{i}^{H} {\hat{v}}_{i}} .$$

Thus, the mutual information achieved by each user 20 may saturate as P_{T} goes high. Moreover, as the number of bits allotted for feedback from each user 20 increases, the mutual information achieved by each user 20 may saturate at higher P_{T}. Accordingly, given a transmit power value P, an increase in P may require an increase in the allotted number of bits for feedback from each user 20 to the base station 10 to avoid saturation of the mutual information when P_{T}<P. If the system 200 experiences only a degradation in the desired signal power and no residual inter-user interference, then the SINR of the k^{th} user 20 may become

$$\frac{{P}_{T}}{K} {α}_{k}$$

and the point at which the mutual information may start to saturate can be expressed as:

$$\frac{{α}_{k}}{{β}_{k}} = \frac{{P}_{T}}{K} {α}_{k} ⇒ {P}_{T} = \frac{K}{{β}_{k}} . \qquad ( 26 )$$

Thus, a smaller βₖ is needed if it is desired to keep the mutual information increasing as transmit power increases. In turn, this requires more bits allotted for channel feedback from each user 20, i.e., more accurate channel state information is needed at the base station 10, so that the inter-user interference may be better eliminated.

Similarly, the mutual information achieved by single-user transmission with limited feedback can be expressed as follows:

$${I}_{k}^{SU\_LF} = \frac{1}{K} {log}_{2} ( 1 + {P}_{T} {γ}_{k} ) , k = 1 , … , K , \qquad ( 27 )$$

where γₖ=hₖ\hat{v}ₖ\hat{v}ₖ^{H}hₖ^{H} and the factor 1/K occurs due to the fact that each of the K users 20 may only be allotted 1/K of the total transmission timeline due to time division. It should be appreciated from Equation (27) that the mutual information achieved by single-user transmission increases logarithmically with P_{T}. As a result, multi-user transmission may perform inferior to single-user transmission if the number of feedback bits is fixed as P_{T} increases.

When the system transmit power is low, i.e., P_{T}→0, achieved mutual information may conform to the following:

$${lim}_{{P}_{T} -> 0} \frac{E [ {I}_{K}^{MU\_LF} ]}{E [ {I}_{k}^{SU\_LF} ]} = {lim}_{{P}_{T} -> 0} \frac{E [ {log}_{2} ( 1 + ( \frac{{P}_{T}}{K} {α}_{k} ) / ( 1 + \frac{{P}_{T}}{K} β ) ) ]}{E [ \frac{1}{K} {log}_{2} ( 1 + {P}_{T} {γ}_{k} ) ]} {=}^{( a )} {lim}_{{P}_{T} -> 0} \frac{E [ \begin{matrix}( 1 / \{ 1 + ( \frac{{P}_{T}}{K} {α}_{k} ) / ( 1 + \frac{{P}_{T}}{K} {β}_{k} ) \} ) \times \\ ( \{ \frac{{α}_{k}}{K} ( 1 + \frac{{P}_{T}}{K} {β}_{k} ) - \frac{{P}_{T}}{K} {α}_{k} \frac{{P}_{T}}{K} {β}_{k} \} / {( 1 + \frac{{P}_{T}}{K} {β}_{k} )}^{2} )\end{matrix} ]}{E [ \frac{1}{K} \frac{{γ}_{k}}{1 + {P}_{T} {γ}_{k}} ]} = \frac{E [ {α}_{k} / K ]}{E [ {γ}_{k} / K ]} = \frac{E [ \frac{{\hat{v}}_{k}^{H} {\hat{\overline{V}}}_{k} {\hat{\overline{V}}}_{k}^{H} {v}_{k}^{H} {v}_{k} {\hat{\overline{V}}}_{k} {\hat{\overline{V}}}_{k}^{H} {\hat{v}}_{k}}{{\hat{v}}_{k}^{H} {\hat{\overline{V}}}_{k} {\hat{\overline{V}}}_{k}^{H} {\hat{v}}_{k}} ]}{E [ {\hat{v}}_{k}^{H} {v}_{k} {v}_{k}^{H} {\hat{v}}_{k} ]} , \qquad ( 28 )$$

where the portion of Equation (28) denoted as (a) follows because, in a case such as that expressed by Equation (28), a limit may be brought through an integral and the order of derivative and integral may interchange according to the Lebesgue dominated convergence theorem. Additionally, it can be observed from Equation (28) that there is only a SNR degradation introduced by limited feedback when P_{T}→0 and that the residual inter-user interference does not play a role. It should be appreciated that this is contrary to the high P_{T} case noted above, where the residual inter-user interference has a significant impact on performance.

In one example, the following inequality can hold for system 200:

$$E [ \frac{{\hat{v}}_{k}^{H} {\hat{\overline{V}}}_{k} {\hat{\overline{V}}}_{k}^{H} {v}_{k} {v}_{k}^{H} {\hat{\overline{V}}}_{k} {\hat{\overline{V}}}_{k}^{H} {\hat{v}}_{k}}{{\hat{v}}_{k}^{H} {\hat{\overline{V}}}_{k} {\hat{\overline{V}}}_{k}^{H} {\hat{v}}_{k}} ] \leq E [ {v}_{k}^{H} {\hat{\overline{V}}}_{k} {\hat{\overline{V}}}_{k}^{H} {v}_{k} ] , \qquad ( 29 )$$

and therefore if RVQ is used, based on Equation (24) and a case where system 200 has two users 20,

$$E [ {v}_{k}^{H} {\hat{\overline{V}}}_{k} {\hat{\overline{V}}}_{k}^{H} {v}_{k} ] = E [ 1 - {v}_{k}^{H} {\hat{v}}_{j} {\hat{v}}_{j}^{H} {v}_{k} ] = B ( 1 , M / ( M - 1 ) ) .$$

This expression can be derived because vₖ and \hat{v}ⱼ are independent M×1 vectors that are isotropically distributed on Ω_{M}. When the number of users 20 in the system 200 equals the number of transmit antennas (e.g., transmit antennas 12) at the base station 10, i.e., K=M, the expression

$$E [ {v}_{k}^{H} {\hat{\overline{V}}}_{k} {\hat{\overline{V}}}_{k}^{H} {v}_{k} ] = 1 - B ( 1 , M / ( M - 1 ) )$$

can be derived since

$${\hat{\overline{V}}}_{k}$$

is an M×1 vector that is isotropically distributed on Ω_{M} and independent of vₖ. In addition, from the expression E[\hat{v}ₖ^{H}vₖvₖ^{H}\hat{v}ₖ]≧1−2^{-N/(M-1)}, the following expressions may be obtained:

$$\begin{matrix}{lim}_{{P}_{T} -> 0} \frac{E [ {I}_{k}^{MU\_LF} ]}{E [ {I}_{k}^{SU\_LF} ]} \leq \frac{B ( 1 , M / ( M - 1 ) )}{1 - {2}^{- N / ( M - 1 )}} , K = 2 , \\ and & ( 30 ) \\ {lim}_{{P}_{T} -> 0} \frac{E [ {I}_{k}^{MU\_LF} ]}{E [ {I}_{k}^{SU\_LF} ]} \leq \frac{1 - B ( 1 , M / ( M - 1 ) )}{1 - {2}^{- N / ( M - 1 )}} , K = M . & ( 31 )\end{matrix}$$

It should be appreciated that Equations (30) and (31) represent upper bounds since only the SNR degradation in the denominator is considered. If the SNR degradation in the numerator and the denominator of Equations (30) and (31) are approximately equal, the following expressions may also be obtained:

$$\begin{matrix}{lim}_{{P}_{T} -> 0} \frac{E [ {I}_{k}^{MU\_LF} ]}{E [ {I}_{k}^{SU\_LF} ]} ≅ E [ {v}_{k}^{H} {\hat{\overline{V}}}_{k} {\hat{\overline{V}}}_{k}^{H} {v}_{k} ] , \\ and & ( 32 ) \\ {lim}_{{P}_{T} -> 0} \frac{E [ {I}_{k}^{MU\_LF} ]}{E [ {I}_{k}^{SU\_LF} ]} ≅ B ( 1 , M / ( M - 1 ) ) , K = 2 , & ( 33 ) \\ {lim}_{{P}_{T} -> 0} \frac{E [ {I}_{k}^{MU\_LF} ]}{E [ {I}_{k}^{SU\_LF} ]} ≅ B ( 1 , M / ( M - 1 ) ) , K = M . & ( 34 )\end{matrix}$$

### When the feedback sent by the users 20 to the base station 10 is perfect, equality holds for Equations (32)-(34). Thus, in a system with limited feedback capacity

$${lim}_{{P}_{T} -> 0} \frac{E [ {I}_{k}^{MU\_LF} ]}{E [ {I}_{k}^{SU\_LF} ]}$$

may get closer to Equations (32)-(34) as the number of bits allotted for feedback in the system increases.

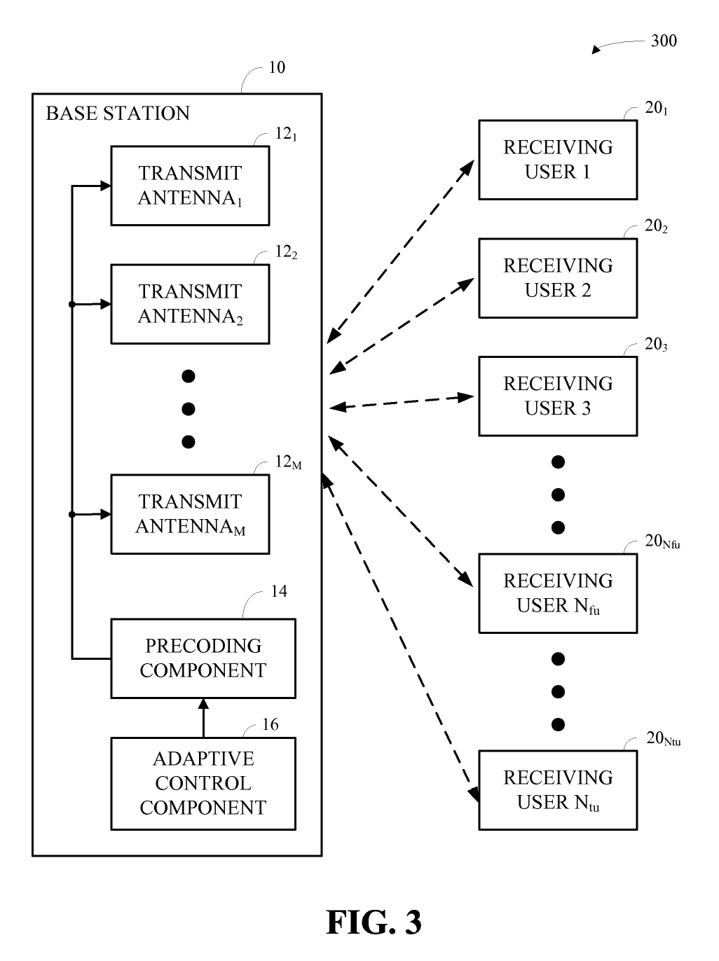

Referring now to FIG. 3, an exemplary wireless communication system 300 in accordance with an aspect of the present invention is illustrated. Similar to system 100, system 300 includes a base station 10 having a plurality of transmit antennas 12 and a precoding component 14 that can coordinate non-cooperative feedback-based multi-user transmission for a plurality of receiving users 20 in a similar manner to that described above with regard to system 200. In accordance with one aspect, the base station 10 may further include an adaptive control component 16 that can adapt the transmission scheme utilized by the system 300 to further improve the performance of the system 300. As a non-limiting example, multi-user transmission may outperform single-user transmission in the system 300 when the overall SNR of the system 300 is high and the base station 10 has perfect channel state information from the users 20. However, the mutual information achieved by multi-user transmission may saturate and become inferior to that achieved by single-user transmission when the users 20 are allotted a limited amount of feedback as described above with regard to system 200. Thus, adaptive control component 16 may identify conditions under which multi-user transmission yields better performance than single-user transmission and vice versa and adapt the transmission scheme utilized by the system 300 accordingly to improve the performance of the system 300 when increasing the number of feedback bits allotted for each user 20 is not a desirable option. In one example of the present invention, adaptive control component 16 may also operate to exploit multi-user diversity when the number of active users 20 in the system 300 is larger than K.

As an example, as the SNR of the system 300 increases, feedback quality may need to improve accordingly to prevent performance saturation in the system 300. To increase the feedback quality, the feedback load corresponding to each user 20 may need to increase linearly with SNR to keep system performance close to that with perfect CSI. In practice, however, increasing the number of feedback bits may lead to an increase in feedback overhead as well as an exponential increase in the required codebook size employed by the system 300. This can cause the search space of each user 20 to increase, which may lead to added complexity and delay in searching for a desired codeword. In addition, added feedback load can lead to an exponential increase in the required amount of memory for each user 20. Thus, the adaptive control component 16 can improve the performance of the system 300 without the negative effects associated with increased feedback load.

In accordance with one aspect, the adaptive control component 16 may operate as follows. From Equation (14), it should be appreciated that the upper-bound of the residual inter-user interference decreases as hₖ\hat{v}ₖ\hat{v}ₖ^{H}hₖ^{H} increases. Thus, given a certain channel realization, the channel norm may be fixed and the adaptive control component 16 may utilize the parameter ρₖ=vₖ^{H}\hat{v}ₖ\hat{v}ₖ^{H}vₖ. The adaptive control component 16 may utilize the parameter ρₖ, for example, because the joint null-space can be determined using only the channel direction. The closer the quantized channel direction to the true one, the more accurate the determined joint null-space will be, thereby allowing inter-user interference to be better eliminated. As a result, ρₖ can be used by the adaptive control component 16 as an indicator for the quality of the feedback from the users 20, thereby providing a measurement for how well multi-user transmission can perform in the system 300. In one example, the adaptive control component 16 and/or each user 20 may then generate and utilize a threshold δ for ρₖ in order to optimally adapt the transmission scheme used by the system 300.

In one example of the present invention, system 300 can have Nₜᵤ total active users 20. Additionally, each of the users 20 can be configured to provide feedback only when ρₖ≧δ, which means that the feedback quality for the user 20 is good enough for multi-user transmission to perform well. Each of the users 20 can be configured to provide feedback in this manner via the adaptive control component 16 at the base station 10, by a component within the users 20 themselves (e.g., a channel feedback component 22 or another suitable component), and/or by other appropriate means. This feedback can also be referred to as multi-user feedback or MU-feedback. The number of users 20 that can provide MU-feedback may then be defined as N_{fu}. When 2≦N^{fu}≦K, the base station 10 may serve these users 20 simultaneously. If N_{fu}≧K , the adaptive control component 16 can utilize a scheduling algorithm to choose K users 20 out of the N_{fu} feedback-capable users 20 to serve simultaneously. Alternatively, a multi-user outage or MU-outage will occur when N_{fu}≦1. When N_{fu}=1, single-user transmission may be utilized by the system 300. When no users 20 can provide feedback, i.e., N_{fu}=0, a BLAST-type transmission may be used by the base station 10 wherein independent data streams are transmitted from each transmit antenna 12 with equal power to one user 20.

In accordance with an alternative aspect, the adaptive control component 16 may also perform as follows. At the beginning of each frame in the transmission timeline for the system 300, the adaptive control component 16 at the base station 10 may choose one default user 20 according to a scheduling algorithm and inform this default user 20 to provide feedback regardless of the value of ρ for the user 20. When ρ≧δ for the user 20, the user 20 may send a high bit (‘1’) back to the base station in addition to the index of the quantized channel direction for the user 20. Alternatively, the user 20 may send back an additional low bit (‘0’) if ρ<δ. If only the chosen default user 20 is found to be capable of providing feedback, then the adaptive control component 16 can instruct the base station 10 to employ single-user transmission. On the other hand, if other users 20 are found to be capable of providing MU-feedback, then the base station 10 may or may not be instructed to serve the selected default user 20 by the adaptive control component 16 based on, for example, whether the additional bit sent back by the default user is ‘1’ or ‘0’ and/or, when N_{fu}>K, the scheduling algorithm used by the adaptive control component 16.

By way of non-limiting example, the adaptive control component 16 and/or users 20 may select the feedback threshold 5 corresponding to when the feedback quality ρₖ for a user 20 is good enough for efficient multi-user transmission through simulation. The adaptive control component 16 and/or users 20 may also perform the necessary simulation to determine the threshold δ offline, thereby avoiding any extra complexity in the operation of the system 300. In one specific, non-limiting example, the simulation may be conducted as follows. First, numerical simulation may be utilized to find the smallest δ that satisfies E[I^{MU}^{_{—}}^{LF}|ρ≧δ]≧E[I^{SU}^{_{—}}^{LF}|ρ≧δ] given P_{T}, M, and K. In this example, all users 20 in the system 300 will share a common threshold. The numerical simulation can be performed, for example, by simulating a large number of channel realizations for different values of δ given P_{T}, M, and Nₜᵤ=K. When each of the K users in the simulation have ρₖ≧δ, multi-user transmission is used; otherwise, single-user transmission is employed. Based on these simulations, the δ that yields the maximum ergodic sum mutual information can be found to be the smallest δ that satisfies E[I^{MU}^{_{—}}^{LF}|ρ≧δ]≧E[I^{SU}^{_{—}}^{LF}|ρ≧δ]. If the threshold utilized is too small, multi-user transmission will be used even when the feedback quality of the users 20 is not sufficient, which can lead to a decrease in ergodic sum mutual information. On the other hand, if the utilized threshold is too large, single-user transmission will be used even in cases where the feedback quality of the users 20 is good enough to exploit the benefit of multi-user transmission, which may also lead to a decrease in ergodic sum mutual information. Thus, an optimal threshold δ may be selected that best balances the mutual information achieved from both single-user and multi-user transmission. Further, it should be appreciated that the feedback threshold determined using the above approach does not depend on the number of feedback bits, as the parameter ρ is the sole measure of feedback quality used in the determination. It should be appreciated that the different performance achieved by different numbers of feedback bits is caused by the difference in the distribution of ρ associated with the different numbers of feedback bits; thus, the larger the number of feedback bits, the better the feedback quality in distribution.

By way of an alternative non-limiting example, the adaptive control component 16 and/or users 20 may also select the feedback threshold δ corresponding to when the feedback quality ρₖ for a user 20 is good enough for efficient multi-user transmission through computational analysis. The analysis may begin by evaluating the SINR of the system 300. As can be appreciated from Equation (25), the expression for SINR is very complicated, which may make the analysis intractable. In order to make the analysis tractable, it may be assumed for purposes of analysis that Nₜᵤ is sufficiently large such that K users 20 can always be found that have approximately orthogonal quantized channel direction, i.e., ∥\hat{v}ᵢ^{H}\hat{v}ⱼ∥≈0, i≠j. Based on this assumption, Equation (25) can be simplified as follows:

$${SINR}_{k} = \frac{{α}_{k}}{{β}_{k} + K / {P}_{T}} {\approx }^{( a )} \frac{{\hat{v}}_{k}^{H} {h}_{k}^{H} {h}_{k} {\hat{v}}_{k}}{{\sum }_{i = 1 , i \neq k}^{K} {\hat{v}}_{i}^{H} {h}_{k}^{H} {h}_{k} {\hat{v}}_{i} + K / {P}_{T}} {\approx }^{( b )} \frac{{‖ {h}_{k} ‖}^{2} {ρ}_{k}}{\frac{K - 1}{M - 1} {‖ {h}_{k} ‖}^{2} ( 1 - {ρ}_{k} ) + K / {P}_{T}} , \qquad ( 35 )$$

where the portion of Equation (35) denoted as (a) follows because \hat{v}ᵢ^{H}\hat{v}ⱼ≈0 for i≠j, and the approximation in Equation (35) denoted as (b) follows from the fact that \hat{v}ₖ is a M×1 vector which spans a one-dimensional subspace in C^{M}. It may then be further assumed for purposes of analysis that [u₁, u₂, . . . ,u_{M-1}] is a set of the orthonormal basis of the (M−1)-dimensional subspace ^{⊥}. Further, \hat{v}ᵢ, i≠k can be any set of approximately orthonormal vectors in ^{⊥}. Thus, [u₁, u₂, . . . ,u_{M-1}] can always be chosen without loss of generality such that (K−1) elements of {u₁, u₂, . . . ,u_{M 1}} are aligned with each \hat{v}ᵢ,i≠k . Based on this, the following can be derived:

$${[ {\hat{v}}_{k} , {u}_{1} , {u}_{2} , … , {u}_{M - 1} ] [ {\hat{v}}_{k} , {u}_{1} , {u}_{2} , … , {u}_{M - 1} ]}^{H} \approx I ⇒ {h}_{k} ( {u}_{1} {u}_{1}^{H} + {u}_{2} {u}_{2}^{H} + … + {u}_{M - 1} {u}_{M - 1}^{H} ) {h}_{k}^{H} \approx {‖ {h}_{k} ‖}^{2} ( 1 - {ρ}_{k} ) , {⇒}^{( c )} {\sum }_{i = 1 , i \neq k}^{K} {h}_{k} {\hat{v}}_{i} {\hat{v}}_{i}^{H} {h}_{k}^{H} \approx \frac{K - 1}{M - 1} {‖ {h}_{k} ‖}^{2} ( 1 - {ρ}_{k} ) \qquad ( 36 )$$

where the portion of Equation (36) denoted as (c) follows since \hat{v}ᵢ,i≠k can be in any (K−1) dimensions of ^{⊥} and the interference caused by \hat{v}ᵢ,i≠k on average can be (K−1)/(M−1) of the total power of hₖ projected in ⁻. The feedback threshold can then be chosen such that:

$${log}_{2} ( 1 + \frac{{‖ {h}_{k} ‖}^{2} {ρ}_{k}}{\frac{K - 1}{M - 1} {‖ {h}_{k} ‖}^{2} ( 1 - {ρ}_{k} ) + K / {P}_{T}} ) \geq \frac{1}{K} {log}_{2} ( 1 + {P}_{T} {‖ {h}_{k} ‖}^{2} {ρ}_{k} ) , \\ k = 1 , … , K . \qquad ( 37 )$$

For a system 300 with two simultaneous users 20, the following closed-form expression for the feedback threshold can then be obtained through derivation:

$${ρ}_{k} \geq {δ}_{k} = 1 - ( M - 1 ) \frac{\sqrt{{( M + 1 )}^{2} + 4 {P}_{T} {‖ {h}_{k} ‖}^{2} -} ( M + 1 )}{2 {P}_{T} {‖ {h}_{k} ‖}^{2}} , \\ k = 1 , 2. \qquad ( 38 )$$

### Because the instantaneous mutual information is utilized in Equation (37), the selected threshold may depend on the instantaneous channel gain.

In accordance with one aspect, the value of P_{T} and the number of transmit antennas 12, denoted as M, in the system may effect the chosen threshold δₖ as illustrated in the following description. First, the derivative of δₖ can be taken with respect to P_{T} to obtain the following:

$$\begin{matrix}\frac{\partial {δ}_{k}}{\partial {P}_{T}} = - \frac{M - 1}{2 {‖ {h}_{k} ‖}^{2} {P}_{T}^{2} \sqrt{\begin{matrix}{( M + 1 )}^{2} + \\ 4 {‖ {h}_{k} ‖}^{2} {P}_{T}\end{matrix}}} \times [ \begin{matrix}\sqrt{\begin{matrix}{( M + 1 )}^{4} + \\ 4 {‖ {h}_{k} ‖}^{2} {{P}_{T} ( M + 1 )}^{2}\end{matrix}} - \\ \sqrt{\begin{matrix}{( M + 1 )}^{4} + \\ 4 {‖ {h}_{k} ‖}^{2} {{P}_{T} ( M + 1 )}^{2} + \\ 4 {‖ {h}_{k} ‖}^{4} {P}_{T}^{2}\end{matrix}}\end{matrix} ] , \\ > 0 & ( 39 ) \\ \frac{\partial {δ}_{k}}{\partial {P}_{T}} = - \frac{1}{2 {‖ {h}_{k} ‖}^{2} {P}_{T} \sqrt{\begin{matrix}{( M + 1 )}^{2} + \\ 4 {‖ {h}_{k} ‖}^{2} {P}_{T}\end{matrix}}} \times [ \begin{matrix}\sqrt{\begin{matrix}4 {{M}^{2} ( M + 1 )}^{2} + \\ 16 {‖ {h}_{k} ‖}^{2} {P}_{T} M ( M + 1 ) + \\ 16 {‖ {h}_{k} ‖}^{4} {P}_{T}^{2}\end{matrix}} - \\ \sqrt{\begin{matrix}4 {{M}^{2} ( M + 1 )}^{2} + \\ 16 {‖ {h}_{k} ‖}^{2} {P}_{T} {M}^{2}\end{matrix}}\end{matrix} ] . \\ < 0 & ( 40 )\end{matrix}$$

It should be appreciated from Equations (39) and (40) that δₖ increases as P_{T} increases, which corresponds to the fact that better feedback quality may be required for higher values of P_{T}. On the other hand, it should be appreciated that δₖ is a decreasing function of M, since the greater the number of transmit antennas 12 employed in the system 300, the smaller the interference caused by each dimension of ^{⊥} may be, as demonstrated by Equation (35). In experimentation, this result agrees with the trend of thresholds found by simulation as described above.

In accordance with another aspect, once the adaptive control component 16 and/or users 20 determine how large ρ needs to be for multi-user transmission to perform better than single-user transmission in the system 300, the system 300 must still include at least 2 users 20 capable of MU-feedback to benefit from multi-user transmission. Thus, for efficient system design, it is also useful to know how large Nₜᵤ needs to be to achieve a certain MU-outage probability P_{MU}_{_{—}}ₒᵤₜ given a feedback threshold δ. Additionally and/or alternatively, it is useful to know how large P_{T} can be before the sum mutual information starts to saturate for a given Nₜᵤ and MU-outage probability.

Using properties of RVQ to simplify analysis, the MU-outage probability can be expressed as the following according to Equation (23):

$$\begin{matrix}{P}_{MU\_out} = Pr ( {N}_{fu} < 2 ) = Pr ( {N}_{fu} = 0 ) + Pr ( {N}_{fu} = 1 ) \\ = {( p ( δ ) )}^{{N}_{tu}} + ( \begin{matrix}{N}_{tu} \\ 1\end{matrix} ) {( p ( δ ) )}^{{N}_{tu}^{- 1}} ( 1 - p ( δ ) ) \\ = {( 1 - x )}^{{QN}_{tu}} + {{N}_{tu} ( 1 - x )}^{Q ( {N}_{tu} - 1 )} ( 1 - {( 1 - x )}^{Q} ) \\ = {{N}_{tu} ( 1 - x )}^{Q ( {N}_{tu} - 1 )} - ( {N}_{tu} - 1 ) {( 1 - x )}^{{QN}_{tu}} ,\end{matrix} \qquad ( 41 )$$

where x=(1−δ)^{(M-1)} and it is assumed that each user 20 has a common threshold δ. Further, to determine the relationship between the MU-outage and the number of transmit antennas 12, the following may be obtained:

$$\begin{matrix}\frac{\partial {P}_{MU\_out}}{\partial x} = - {N}_{tu} Q ( {N}_{tu} - 1 ) {( 1 - x )}^{Q ( {N}_{Tu} - 1 ) - 1} + \\ ( {N}_{tu} - 1 ) {{QN}_{tu} ( 1 - x )}^{{QN}_{tu} - 1} \\ = {N}_{tu} ( {N}_{tu} - 1 ) {Q ( 1 - x )}^{Q ( {N}_{tu} - 1 ) - 1} ( {( 1 - x )}^{Q} - 1 ) < \\ 0.\end{matrix} \qquad ( 42 )$$

Based on Equations (41) and (42), it should be appreciated that P_{MU}_{_{—}}ₒᵤₜ is a decreasing function of x . In addition, since x is a decreasing function of M, P_{MU}_{_{—}}ₒᵤₜ is an increasing function of M. This demonstrates that increasing the number of transmit antennas 12 in the system 300 while fixing the number of partitions Q can lead to poor correlation between a codeword and the true channel direction.

Given values for Q, δ and M, the relationship between P_{MU}_{_{—}}ₒᵤₜ and Nₜᵤ can be demonstrated using Equation (41). Thus, it is possible to determine how large Nₜᵤ must be to achieve a desired P_{MU}_{_{—}}ₒᵤₜ. Additionally, given values for Nₜᵤ, Q, M, the relationship between P_{MU}_{_{—}}ₒᵤₜ and δ can be demonstrated. From this relationship, given a desired P_{MU}_{_{—}}ₒᵤₜ, the corresponding δ may be determined, thereby allowing a determination of how large P_{T} can be before the sum mutual information starts to saturate.

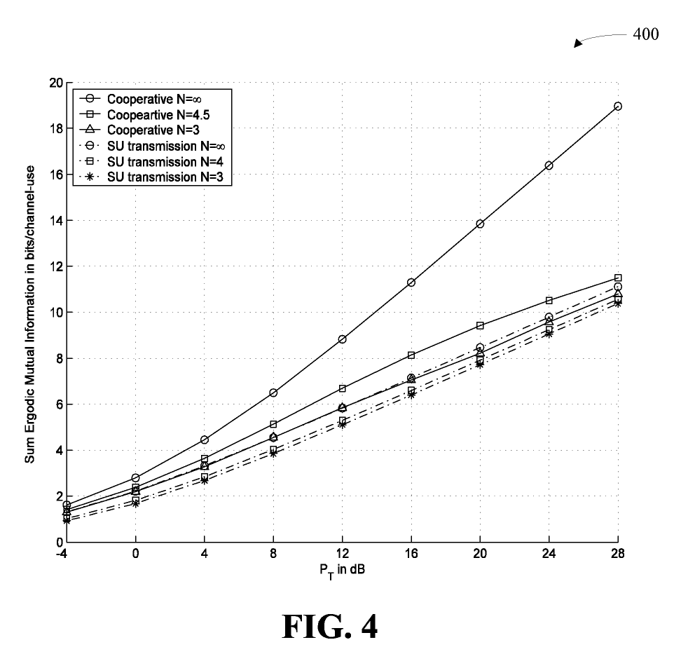

Referring now to FIGS. 4-11, performance data of exemplary systems implemented in accordance with various aspects of the present invention are illustrated and compared with performance data of traditional communication systems. With specific regard to FIG. 4, a graph 400 is provided that illustrates benchmark performance data for a communication system utilizing cooperative feedback-based multi-user transmission and a system utilizing single-user transmission.

In the cooperative feedback-based multi-user transmission scheme illustrated in graph 400, K users can cooperate in the sense that they can jointly provide feedback corresponding to their downlink CSI. Although such a system is unrealistic in practice, it can nonetheless serve as an upper bound of the achievable performance of a realistic MU-MISO transmission scheme with limited feedback. In the case of the cooperative feedback-based multi-user transmission scheme illustrated in graph 400, the design of the optimal feedback and transmission strategy can be similar to the design of an optimal feedback strategy for single-user transmission in that the transmit signal can be designed at the receiver rather than at the transmitter. Thus, the design for such a system is equivalent to the design of a vector quantizer, where the joint channel space h=[h₁, . . . ,h_{K}] is partitioned into Q regions { ⁰, ¹, . . . , ^{Q-1}} and a codebook is constructed which consists of Q transmit beamforming vector sets w^{q}=[w₁^{q}, . . . ,w_{K}_{q}], q=0,Q−1, with w^{q} associates with ^{q}. The objective of the design for the cooperative feedback-based multi-user transmission scheme can be expressed as follows:

$${max}_{{\{ {ℋ}^{0} , … , {ℋ}^{Q - 1} \}}_{\{ {w}^{0} , … , {w}^{Q - 1} \}}} E [ {\sum }_{k = 1}^{K} {I}_{k} ] , \\ such that tr ( {w}^{{q}^{H}} {w}^{q} ) \leq {P}_{T} , \\ q = 0 , … , Q - 1 , \qquad ( 43 )$$

or, equivalently:

$$\begin{matrix}{\sum }_{q = 0}^{Q - 1} {max}_{{ℋ}^{q} , {w}^{q}} E [ I ( {w}^{q} , h ) \vert h ∈ {ℋ}^{q} ] Pr ( h ∈ {ℋ}^{q} ) , \\ such that tr ( {w}^{{q}^{H}} {w}^{q} ) \leq {P}_{T} , \\ q = 0 , … , Q - 1 , \\ where & ( 44 ) \\ I ( {w}^{q} , h ) = {\sum }_{k = 1}^{K} {log}_{2} ( 1 + {w}_{k}^{{q}^{H}} {h}_{k}^{H} {h}_{k} {w}_{k}^{q} / ( 1 + {\sum }_{i = 1 , i \neq k}^{K} {w}_{i}^{{q}^{H}} {h}_{k}^{H} {h}_{k} {w}_{i}^{q} ) ) . & ( 45 )\end{matrix}$$

Based on Equations (43)-(45), the codebook for the cooperative multi-user transmission scheme can be designed using an iterative two-step method. First, the optimal transmission strategy w^{q} can be determined given a certain partition ^{q}, q=0, . . . ,Q−1, by using the following equation:

$${w}^{q} = arg {max}_{{w}^{q}} E [ I ( {w}^{q} , h ) \vert h ∈ {ℋ}_{q} ] Pr ( h ∈ {ℋ}^{q} ) , \\ such that tr ( {w}^{{q}^{H}} {w}^{q} ) \leq {P}_{T} . \qquad ( 46 )$$

Second, the optimal partition ^{q} can be determined given a transmission strategy w^{q}, q=0, . . . ,Q−1, by using the following equation:

^{q}={h:I(w^{q},h)≧I(w^{j},h); ∀jε[0, . . . ,q−1,q+1, . . . ,Q−1]}. (47)

Equations (46) and (47) can then be solved iteratively until convergence for several random initial partitions and the resulting codebook that yields the maximum sum ergodic mutual information can then be selected. In the following discussion, the cooperative feedback-based multi-user transmission scheme described above is denoted as “the cooperative approach,” while the non-cooperative approach utilized in accordance with various aspects of the present invention is denoted as “the non-cooperative approach” or, in FIGS. 4-11, simply as “MU.”

As noted previously, it should be appreciated that the optimal partition derived by the non-cooperative approach may also be optimal for a single-user transmission scheme in terms of maximizing the ergodic mutual information, where {\sqrt{P_{T}}v⁰,\sqrt{P_{T}}v¹, . . . ,\sqrt{P_{T}}v^{Q-1}} may be the corresponding optimal codebook. As used in graph 400, N represents the number of bits allotted for feedback for each user (e.g., each user 20). For the cooperative approach, this means the joint channel space can be partitioned into Q=₂^{2N} regions, while for the single-user and non-cooperative approaches, this means the single-user channel space can be partitioned into Q=2^{N} regions. As used in FIGS. 4-11, “Cooperative N=∞” indicates perfect CSI is known at the base station (e.g., the base station 10) and that the beamforming vectors of all users are chosen to maximize the sum mutual information according to Equation (45) subject to a total transmit power constraint. Additionally, as used in FIGS. 4-11, “MU N=∞” means perfect knowledge of the spatial signature is available to the base station and beamforming weights for all users are determined according to Equation (8).

Graph 400 illustrates performance data for the cooperative approach in a system with M=4 and K=2, and compares this performance data with that of single-user transmission. As illustrated by graph 400, when CSI at the base station is perfect, i.e., N=∞, multi-user transmission can achieve a performance gain of approximately 50% over single-user transmission for P_{T}>12 dB . Additionally, graph 400 illustrates that where the capacity of the feedback channel is constrained, the ergodic mutual information achieved by single-user transmission with only 3 or 4 bits allotted for feedback is already very near the mutual information achieved by single-user transmission with perfect CSI. On the other hand, graph 400 illustrates that the performance achievable by multi-user transmission with 4.5 bits feedback is significantly less than that achieved with perfect CSI even if users can cooperate. Thus, graph 400 suggests that multi-user transmission requires more accurate CSI at the base station than that required for single-user transmission.

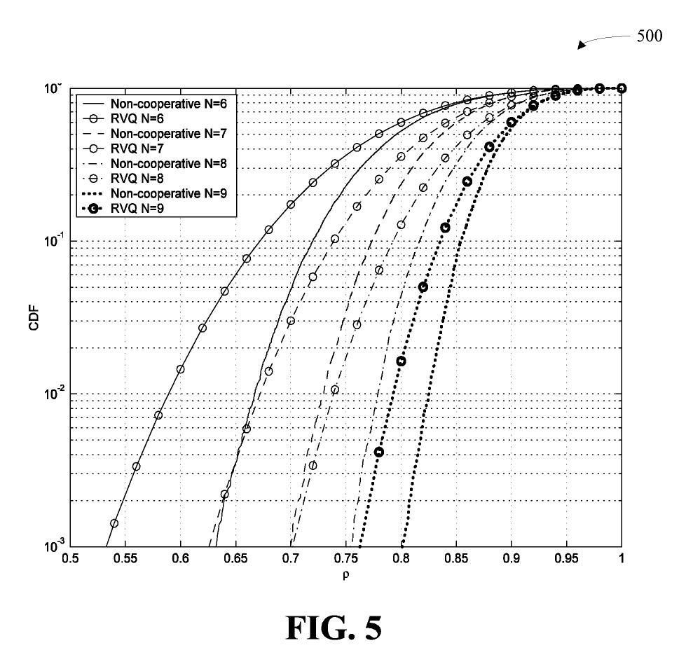

Referring briefly to FIG. 5, a graph 500 is provided that illustrates a comparison between the performance of RVQ for multi-user transmission and the performance of an exemplary non-cooperative approach in accordance with an aspect of the present invention. More particularly, graph 400 illustrates cumulative distribution functions of the correlation ρ=v^{H}\hat{v}\hat{v}^{H}v obtained using a non-cooperative codebook and RVQ to demonstrate the feasibility of the non-cooperative approach. As illustrated by graph 500, RVQ performs close but inferior to the codebook utilized in the non-cooperative approach. Additionally, the similarities between RVQ and the non-cooperative approach illustrated in FIG. 5 justify the use of properties of RVQ in the analysis of the performance of the non-cooperative approach described earlier.

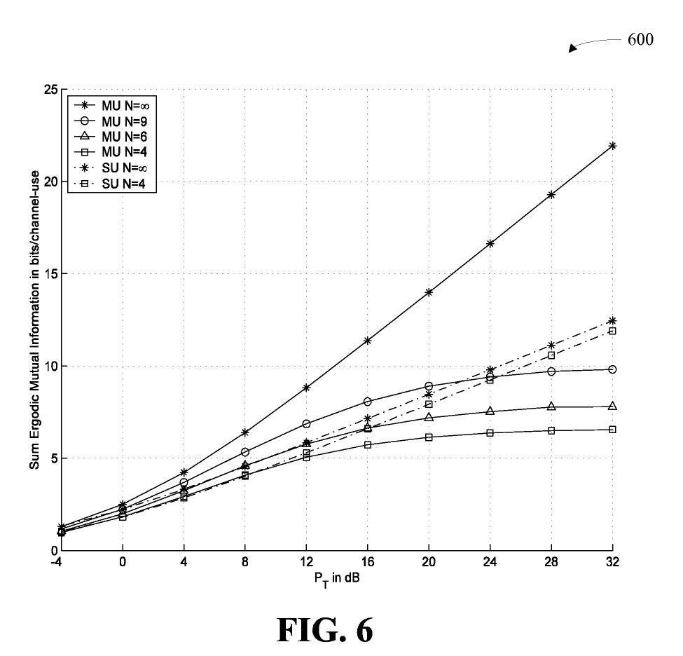

Turning now to FIG. 6, a graph 600 is provided that illustrates a comparison between the performance of a non-cooperative approach in accordance with an aspect of the present invention (denoted in graph 600 as “MU”) and the performance of single-user transmission (denoted in graph 600 as “SU”). Specifically, the performance data for the two approaches is compared in graph 600 for a system having 4 transmit antennas (e.g., transmit antennas 12) and 2 users (e.g., users 20). It should be appreciated that the non-cooperative approach and single-user transmission may require the same kind of information from the users, such as, for example, the spatial direction v of the channel. From graph 600, it can be observed that with 4.5 bits feedback allotted per user, multi-user transmission may perform worse than single-user transmission. This indicates that multi-user transmission needs a more accurate version of v to perform optimally. On the other hand, graph 600 also illustrates that with 6 bits allotted for feedback, the performance achieved by the non-cooperative approach is nearly the same as that of single-user transmission with perfect CSI at the base station (e.g., base station 10) for moderate values of P_{T}. However, it can be seen from graph 600 that the ergodic sum mutual information achieved by the non-cooperative approach starts to saturate for high values of P_{T}. With 9 bits allotted for feedback, graph 600 illustrates that the non-cooperative approach can achieve a gain of 2-4dB over single-user transmission with perfect CSI at the base station for P_{T} between 4dB and 16dB. Additionally, graph 600 shows that the saturation in mutual information with 9 bits allotted for feedback occurs at a higher P_{T} than that of 6 bits allotted for feedback. However, when compared to the cooperative approach illustrated in graph 400, it can be seen that the performance achieved by the non-cooperative approach with 9 bits allotted for feedback per user is similar to that of the cooperative approach with 4.5 bits allotted for feedback at moderate values of P_{T}. Thus, the gap between the performance of the cooperative approach and the non-cooperative approach can be significant in particular cases.

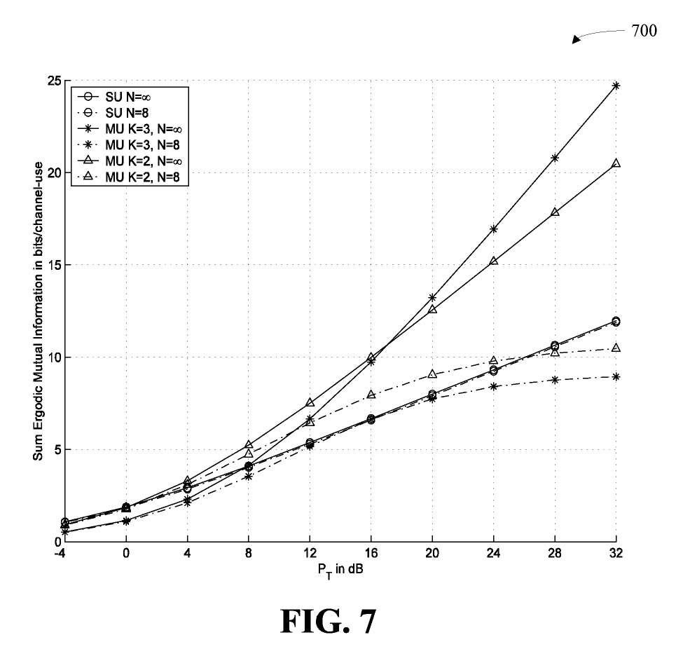

Turning now to FIG. 7, a graph 700 is provided that illustrates a comparison between the performance of a non-cooperative approach in accordance with an aspect of the present invention (denoted in graph 700 as “MU”) and the performance of single-user transmission (denoted in graph 700 as “SU”). Specifically, the performance data for the two approaches is compared in graph 700 for a system having 3 transmit antennas and 3 users. As graph 700 illustrates, the performance of the non-cooperative approach and single-user transmission is similar to that illustrated by graph 600. Additionally, graph 700 illustrates that while overall system performance with 3 simultaneous users is better than that of a system with 2 simultaneous users at high P_{T} when the CSI at the base station is perfect, the overall system performance with 3 simultaneous users may be inferior to that of a system with 2 simultaneous users when there is only limited feedback. This indicates that when the CSI at the base station is imperfect, the system may choose to serve less simultaneous users than that allowed by the antenna configuration due to inter-user interference.

The performance of the non-cooperative approach in the low SNR region is further illustrated by Table 2 below for systems with M=4, K=2 and M=3, K=3:

TABLE 2
r = E[Iₖ^{MU}^{_{—}}^{LF}]/E[Iₖ^{SU}^{_{—}}^{LF}] at P_{T} = −60 dB.

| | | | | | r |
|---|---|---|---|---|---|
| | r | r | r | r | perfect |
| | N = 6 | N = 7 | N = 8 | N = 9 | CSIT |
| M = 4, K = 2, simulation | 0.7700 | 0.7654 | 0.7619 | 0.7589 | 0.7499 |
| M = 4, K = 2, Eq. (30) | 1 | 0.9357 | 0.8902 | 0.8571 | 0.75 |
| | | | | | (Eq. |
| | | | | | (33)) |
| M = 3, K = 3, simulation | 0.3776 | 0.3592 | 0.3509 | 0.3472 | 0.3331 |
| M = 3, K = 3, Eq. (31) | 0.3810 | 0.3657 | 0.3556 | 0.3487 | 0.3333 |
| | | | | | (Eq. |
| | | | | | (34)) |

As can be observed from Table 2, the results obtained from simulation of the non-cooperative approach closely match those obtained from analysis. For example, it can be seen from Table 2 that the simulation results are respectively upper-bounded by Equations (30) and (31). In addition, as the number of bits allotted for feedback increases, the simulation results illustrated by Table 2 approach Equations (33) and (34).

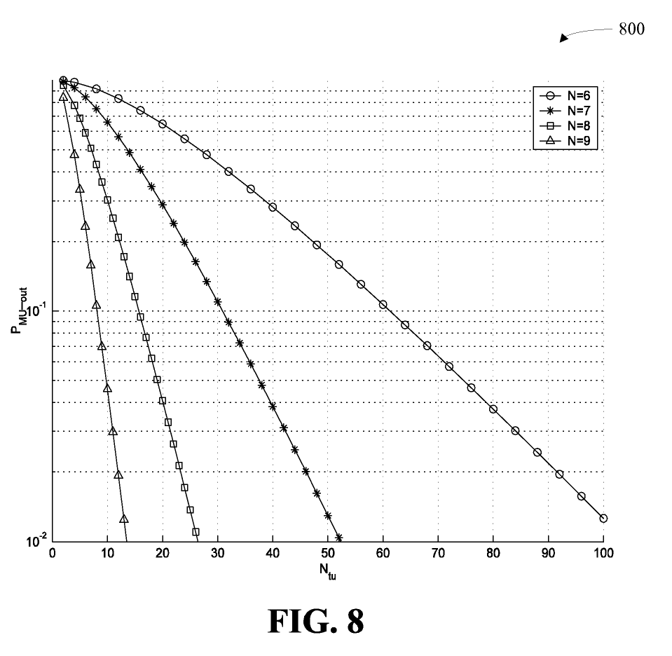

Referring to FIG. 8, a graph 800 is provided that illustrates performance data for an exemplary adaptive non-cooperative approach in accordance with an aspect of the present invention. Specifically, graph 800 illustrates the relationship between P_{MU}_{_{—}}ₒᵤₜ and Nₜᵤ for different numbers of feedback bits using Equation (41) for a system with 4 transmit antennas and a feedback threshold δ=0.9. Graph 800 illustrates that in order to achieve a MU-outage rate of 1%, less than 20 users are needed when 9 bits are allotted for feedback, while more than 100 users are needed when only 6 bits are allotted for feedback. Thus, it can be appreciated that the number of users needed to avoid a MU-outage increases significantly as the number of feedback bits decreases since the distribution of the feedback quality ρ gets worse.

Additionally, feedback thresholds obtained through simulation are provided in Table 3 below for systems with M=4, K=2 and M=5, K=2 for various values of P_{T}:

TABLE 3
Feedback thresholds δ obtained through simulation.

| | δ for | δ for | δ with | | |
|---|---|---|---|---|---|
| | P_{T} = | P_{T} = | P_{T} = | δ with | δ with |
| | 16 dB | 20 dB | 24 dB | P_{T} = 28 dB | P_{T} = 32 dB |
| M = 4, K = 2 | 0.775 | 0.85 | 0.9 | 0.925 | 0.95 |
| M = 5, K = 2 | 0.725 | 0.795 | 0.875 | 0.9 | 0.93 |

### As can be observed from Table 3, δ is an increasing function of P_{T} and a decreasing function of M. This observation agrees with the analysis described earlier.

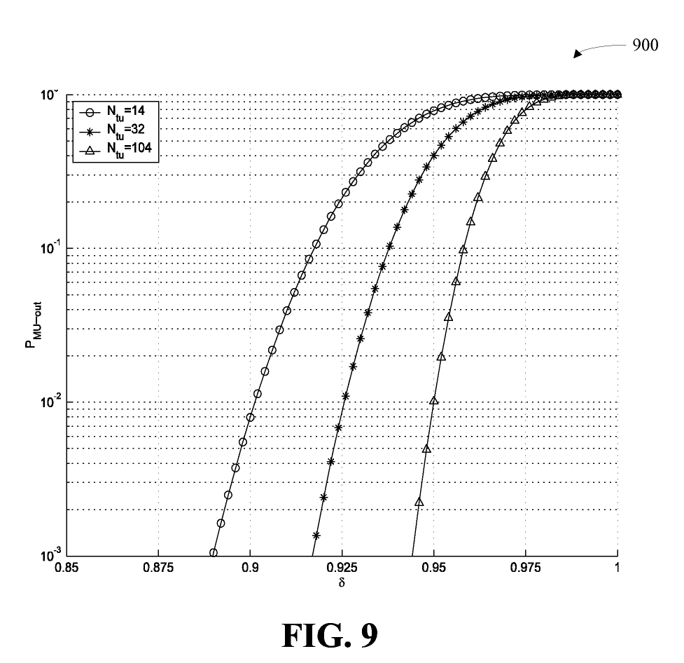

Referring briefly to FIG. 9, a graph 900 is provided that illustrates performance data for an exemplary adaptive non-cooperative approach in accordance with an aspect of the present invention. Specifically, graph 900 illustrates the relationship between P_{MU}_{_{—}}ₒᵤₜ and the feedback threshold δ for different numbers of total users Nₜᵤ in a system with 4 transmit antennas and 9 bits allotted for feedback. As illustrated by graph 900, the number of users needed to achieve a 1% MU-outage rate for δ=0.9, 0.925, 0.95 is 14, 32, and 104, respectively.

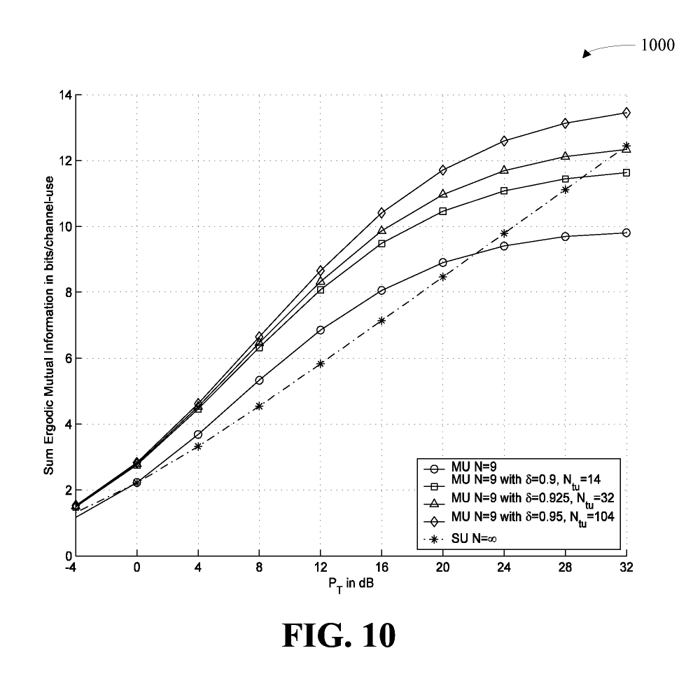

Turning now to FIG. 10, a graph 1000 is provided that illustrates a comparison between the performance of an exemplary communication system utilizing an adaptive non-cooperative approach in accordance with an aspect of the present invention and a similar system utilizing single-user transmission. In accordance with one aspect of the present invention, the adaptive non-cooperative threshold-based approach utilizes a threshold-based feedback mechanism such that only users whose feedback quality is good enough for multi-user transmission are allowed to provide MU-feedback. In addition, multi-user diversity in the sense of feedback quality rather than channel quality itself can than be exploited when there are several users in the system. Graph 1000 illustrates the performance achieved by an adaptive non-cooperative threshold-based approach with δ=0.9, Nₜᵤ=14, δ=0.925, Nₜᵤ=32 and δ=0.95, Nₜᵤ=104 in a system with 4 transmit antennas that may serve 2 users simultaneously and 9 bits allotted for feedback. In the exemplary adaptive non-cooperative threshold-based approach illustrated by graph 1000, a default user is selected in a round-robin fashion, and 2 users are chosen whose inter-user correlation ∥\hat{v}ᵢ^{H}\hat{v}ⱼ∥² is the smallest to serve simultaneously when N_{fu}>2. It should be appreciated, however, that this is merely one way in which users may be scheduled for such an approach and that other approaches are possible.

As illustrated by Table 3 above, the three thresholds illustrated in graph 1000 respectively correspond to P_{T}=24, 28, 32 dB. Further, as illustrated by graph 1000, the thresholds obtained from simulation as illustrated in Table 3 yield an overall system performance that is better than single-user transmission at each corresponding P_{T}. Additionally, because the two users with the smallest inter-user correlation are chosen, the crossover point at which single-user transmission outperforms the adaptive non-cooperative threshold-based approach occurs later than each corresponding P_{T}. With 32 total users in the system, graph 1000 further illustrates that the adaptive non-cooperative threshold-based approach can achieve a 30%-45% performance gain over single-user transmission with perfect CSI at the base station for P_{T} between 4 dB and 20 dB. Thus, if a system operates in this P_{T} region, it may be very beneficial to use multi-user transmission with the adaptive non-cooperative threshold-based approach. Further, if there are more users in the system, an even larger performance gain can be achieved since a larger feedback threshold can be applied, thereby improving the overall feedback quality.

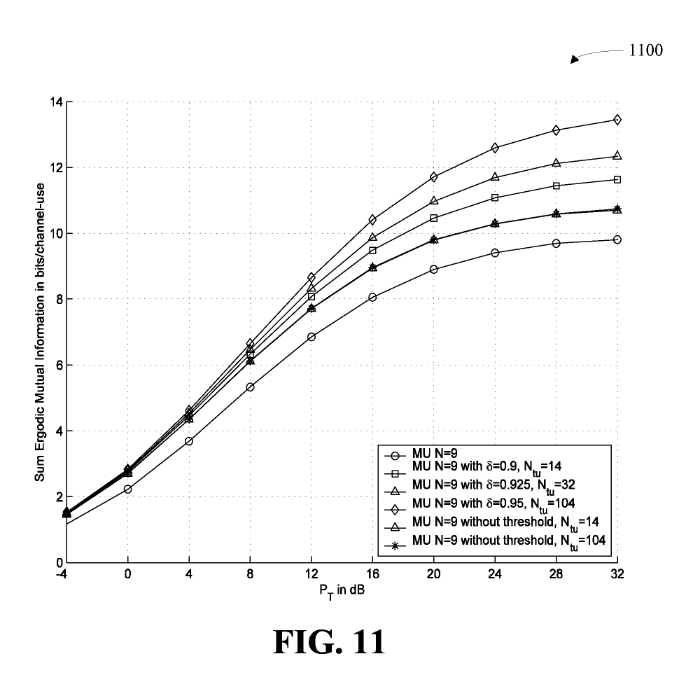

Referring to FIG. 11, a graph 1100 is provided that illustrates a comparison between the performance of an exemplary non-cooperative approach and an exemplary adaptive non-cooperative threshold-based approach in accordance with various aspects of the present invention. More particularly, graph 1100 demonstrates the performance gain that can be achieved with an adaptive non-cooperative threshold-based approach for the same system used for graph 1000 due to the improvement in the feedback quality provided by said approach. For the non-adaptive approach illustrated by graph 1100, all Nₜᵤ users provide feedback, from which the base station selects two users with the smallest ∥\hat{v}ᵢ^{H}\hat{v}ⱼ∥² to serve simultaneously. As can be seen from graph 1100, the performance achieved with 14 users and 104 users are nearly the same for the non-adaptive approach. Further, it can be seen that both of these performance measures are lower than that achieved by the adaptive approach with 14 users. Further, the adaptive approach shows performance gains in graph 1100 of 10-15% with 32 users and even higher performance gains for higher number of users. Thus, the gain obtained by choosing users who have nearly orthogonal quantized channel direction is limited and may not be able to further improve system performance even with a large number of users. Additionally, a byproduct of the adaptive approach illustrated in graph 1100 is that overall feedback overhead for the system may be reduced.

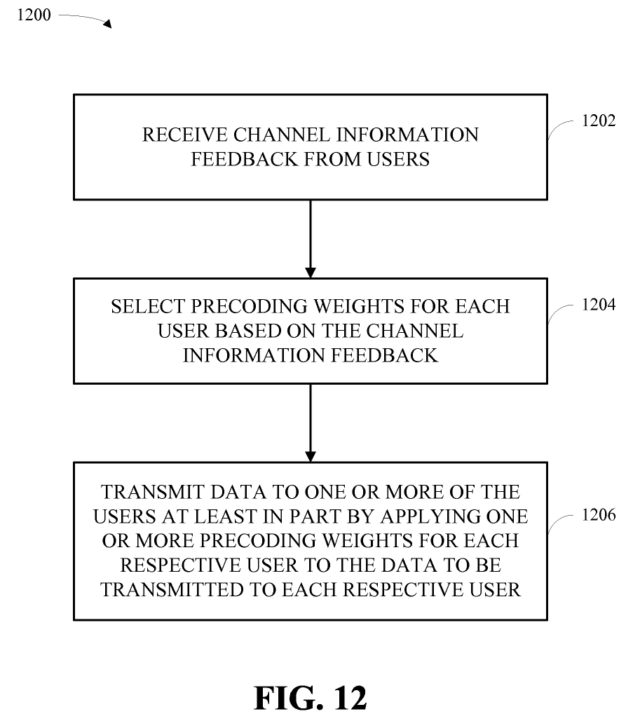

Turning briefly to FIGS. 12-14, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

Referring to FIG. 12, a method 1200 of non-cooperative feedback-based multi-user transmission in a wireless communication system (e.g., system 200) in accordance with an aspect of the present invention is illustrated. At 1202, channel information feedback is received (e.g., by a base station 10) from one or more users (e.g., users 20). In one example, feedback can be generated and communicated by each user via a channel feedback component (e.g., a channel feedback component 22). At 1204, precoding weights are selected for each user (e.g., by a precoding component 14 at the base station 10) based on the received channel information feedback for each user. Finally, at 1206, data are transmitted to one or more of the users at least in part by applying precoding weights corresponding to the each respective user to the data to be transmitted to each user.

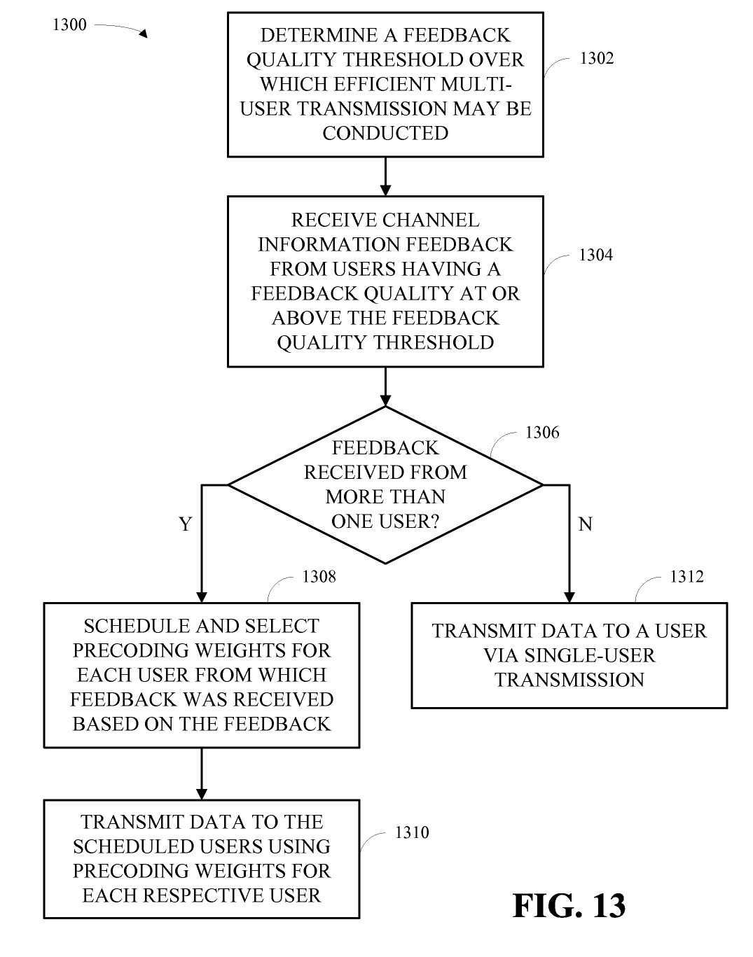

Referring to FIG. 13, a method 1300 of adaptive non-cooperative feedback-based multi-user transmission in a wireless communication system (e.g., system 300) in accordance with an aspect of the present invention is illustrated. At 1302, a feedback quality threshold is determined over which efficient multi-user transmission may be conducted in the system. At 1304, channel information feedback is received (e.g., by a base station 10) from one or more users (e.g., users 20) having a feedback quality that is at or above the feedback quality threshold determined at 1302. In one example, feedback can be generated and communicated by each user at 1304 via a channel feedback component (e.g., a channel feedback component 22). At 1306, a determination is made (e.g., by an adaptive control component 16) regarding whether feedback has been received from more than one user. If it is determined at 1306 that feedback has been received from more than one user, method 1300 continues to 1308, where scheduling and precoding weights are selected for each user from which feedback was received based on the received feedback, and to 1310, where data are transmitted to the users scheduled at 1308 using the precoding weights selected for each respective user. On the other hand, if it is determined at 1306 that feedback has not been received from more than one user, a MU-outage has occurred and method 1300 proceeds to 1312, where data are transmitted to a single user via single-user transmission.

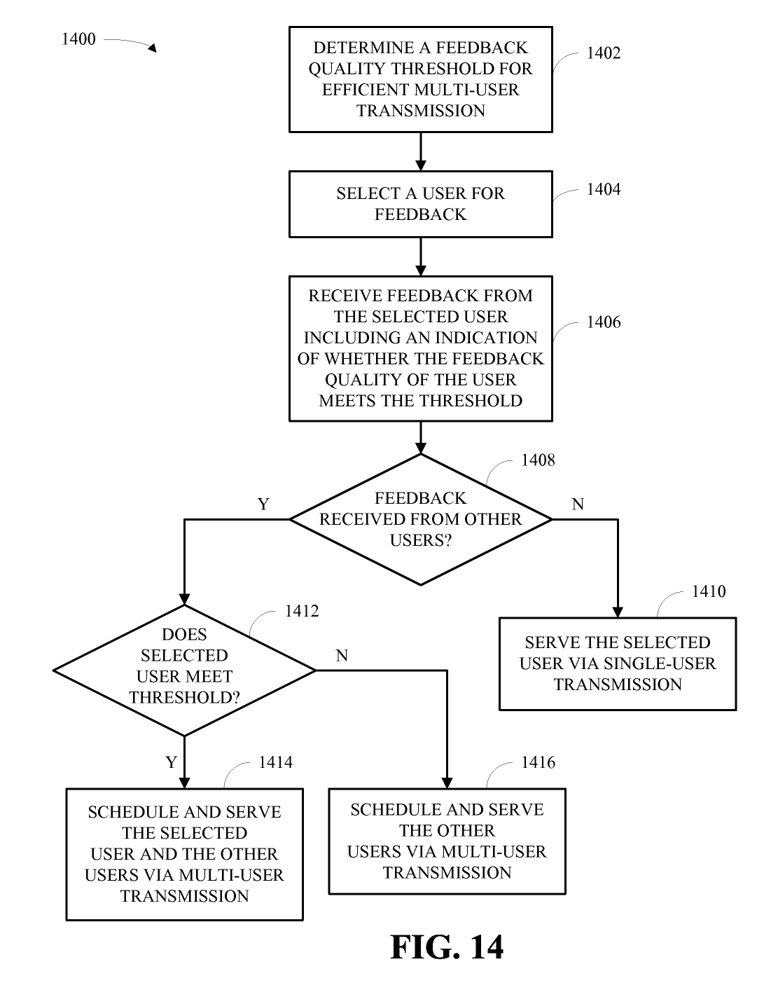

Referring to FIG. 14, a method 1400 of adaptive non-cooperative feedback-based multi-user transmission in a wireless communication system (e.g., system 300) in accordance with an aspect of the present invention is illustrated. At 1402, a feedback quality threshold is determined over which efficient multi-user transmission may be conducted in the system. At 1404, a user (e.g., a user 20) is selected (e.g., by an adaptive control component 16 at a base station 10) to provide feedback. At 1406, feedback is received from the user that was selected at 1404 that includes an indication of whether the feedback quality of the selected user meets the threshold determined at 1402. In one example, feedback can be generated and communicated by the selected at 1406 via a channel feedback component (e.g., a channel feedback component 22). At 1408, a determination is made regarding whether feedback has been received from other users in the system. If the determination at 1408 is negative, method 1400 concludes at 1410, where the selected user is served via single-user transmission. Otherwise, method 1400 continues to 1412. At 1412, the feedback received from the selected user is analyzed to determine whether the feedback quality of the selected user meets the threshold determined at 1402. If the feedback quality of the selected user does meet the threshold, method 1400 proceeds to 1414, where the selected user and one or more of the other users found at 1408 are scheduled and then served via multi-user transmission. On the other hand, if the feedback quality of the selected user does not meet the threshold, method 1400 instead proceeds to 1416, where only the other users found at 1408 are scheduled and served via multi-user transmission.

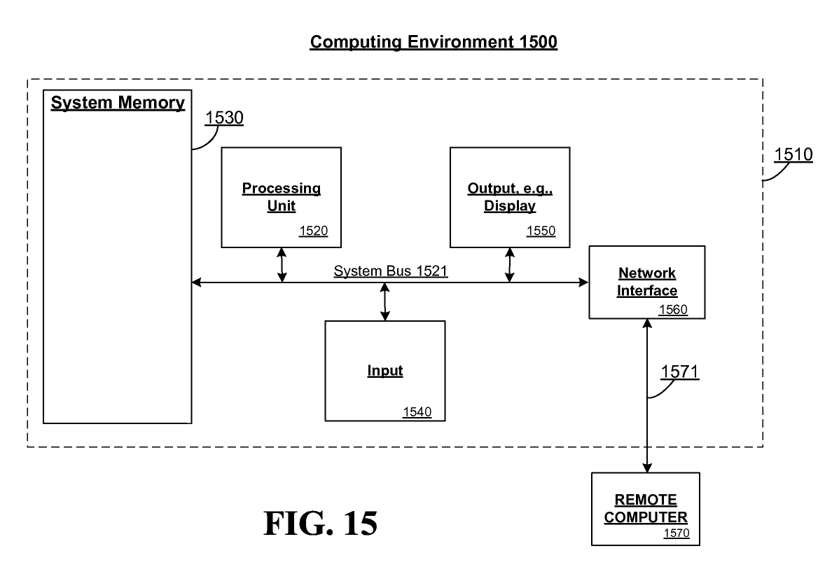

Turning to FIG. 15, an exemplary non-limiting computing system or operating environment in which the present invention may be implemented is illustrated. One of ordinary skill in the art can appreciate that handheld, portable and other computing devices and computing objects of all kinds are contemplated for use in connection with the present invention, i.e., anywhere that a communications system may be desirably configured. Accordingly, the below general purpose remote computer described below in FIG. 15 is but one example of a computing system in which the present invention may be implemented.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 15 thus illustrates an example of a suitable computing system environment 1500 in which the invention may be implemented, although as made clear above, the computing system environment 1500 is only one example of a suitable computing environment for a media device and is not intended to suggest any limitation as to the scope of use or functionality of the invention. Neither should the computing environment 1500 be interpreted as having any dependency or requirement relating to any one or combination of components illustrated in the exemplary operating environment 1500.

With reference to FIG. 15, an example of a remote device for implementing the invention includes a general purpose computing device in the form of a computer 1510. Components of computer 1510 may include, but are not limited to, a processing unit 1520, a system memory 1530, and a system bus 1521 that couples various system components including the system memory to the processing unit 1520. The system bus 1521 may be any of several types of bus structures including a memory bus or memory controller, a peripheral bus, and a local bus using any of a variety of bus architectures.

Computer 1510 typically includes a variety of computer readable media. Computer readable media can be any available media that can be accessed by computer 1510. By way of example, and not limitation, computer readable media may comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1510. Communication media typically embodies computer readable instructions, data structures, program modules or other data in a modulated data signal such as a carrier wave or other transport mechanism and includes any information delivery media.

The system memory 1530 may include computer storage media in the form of volatile and/or nonvolatile memory such as read only memory (ROM) and/or random access memory (RAM). A basic input/output system (BIOS), containing the basic routines that help to transfer information between elements within computer 1510, such as during start-up, may be stored in memory 1530. Memory 1530 typically also contains data and/or program modules that are immediately accessible to and/or presently being operated on by processing unit 1520. By way of example, and not limitation, memory 1530 may also include an operating system, application programs, other program modules, and program data.

The computer 1510 may also include other removable/non-removable, volatile/nonvolatile computer storage media. For example, computer 1510 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1521 through a non-removable memory interface such as an interface, and a magnetic disk drive or optical disk drive is typically connected to the system bus 1521 by a removable memory interface, such as an interface.

A user may enter commands and information into the computer 1510 through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1520 through user input 1540 and associated interface(s) that are coupled to the system bus 1521, but may be connected by other interface and bus structures, such as a parallel port, game port or a universal serial bus (USB). A graphics subsystem may also be connected to the system bus 1521. A monitor or other type of display device is also connected to the system bus 1521 via an interface, such as output interface 1550, which may in turn communicate with video memory. In addition to a monitor, computers may also include other peripheral output devices such as speakers and a printer, which may be connected through output interface 1550.

The computer 1510 may operate in a networked or distributed environment using logical connections to one or more other remote computers, such as remote computer 1570, which may in turn have media capabilities different from device 1510. The remote computer 1570 may be a personal computer, a server, a router, a network PC, a peer device or other common network node, or any other remote media consumption or transmission device, and may include any or all of the elements described above relative to the computer 1510. The logical connections depicted in FIG. 15 include a network 1571, such local area network (LAN) or a wide area network (WAN), but may also include other networks/buses. Such networking environments are commonplace in homes, offices, enterprise-wide computer networks, intranets and the Internet.

When used in a LAN networking environment, the computer 1510 is connected to the LAN 1571 through a network interface or adapter. When used in a WAN networking environment, the computer 1510 typically includes a communications component, such as a modem, or other means for establishing communications over the WAN, such as the Internet. A communications component, such as a modem, which may be internal or external, may be connected to the system bus 1521 via the user input interface of input 1540, or other appropriate mechanism. In a networked environment, program modules depicted relative to the computer 1510, or portions thereof, may be stored in a remote memory storage device. It will be appreciated that the network connections shown and described are exemplary and other means of establishing a communications link between the computers may be used.

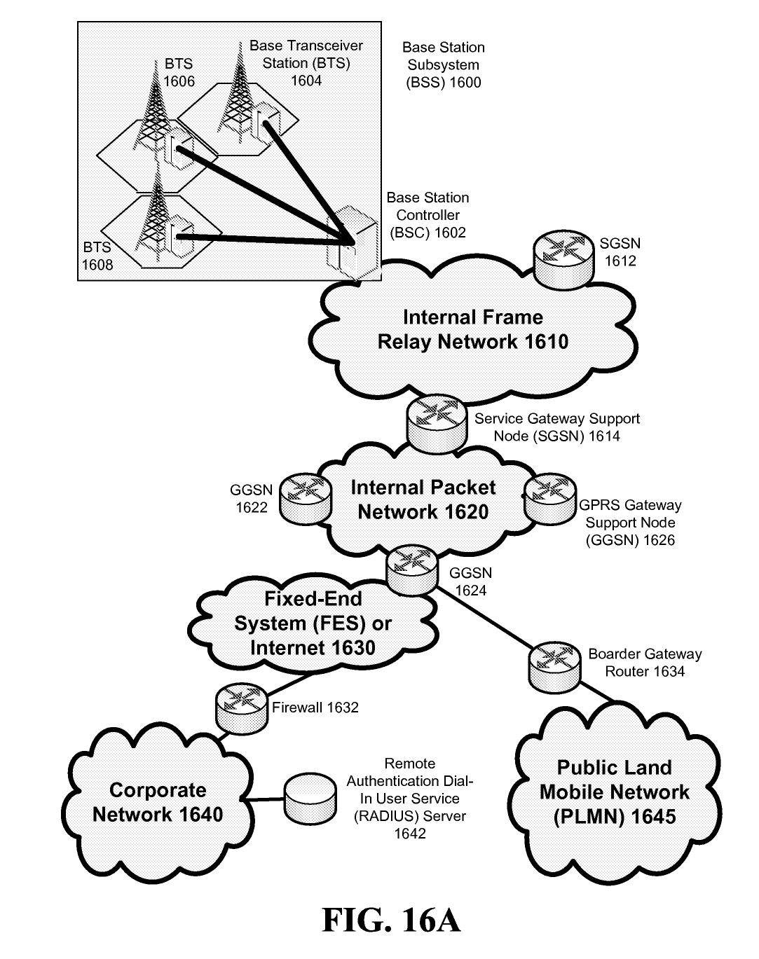

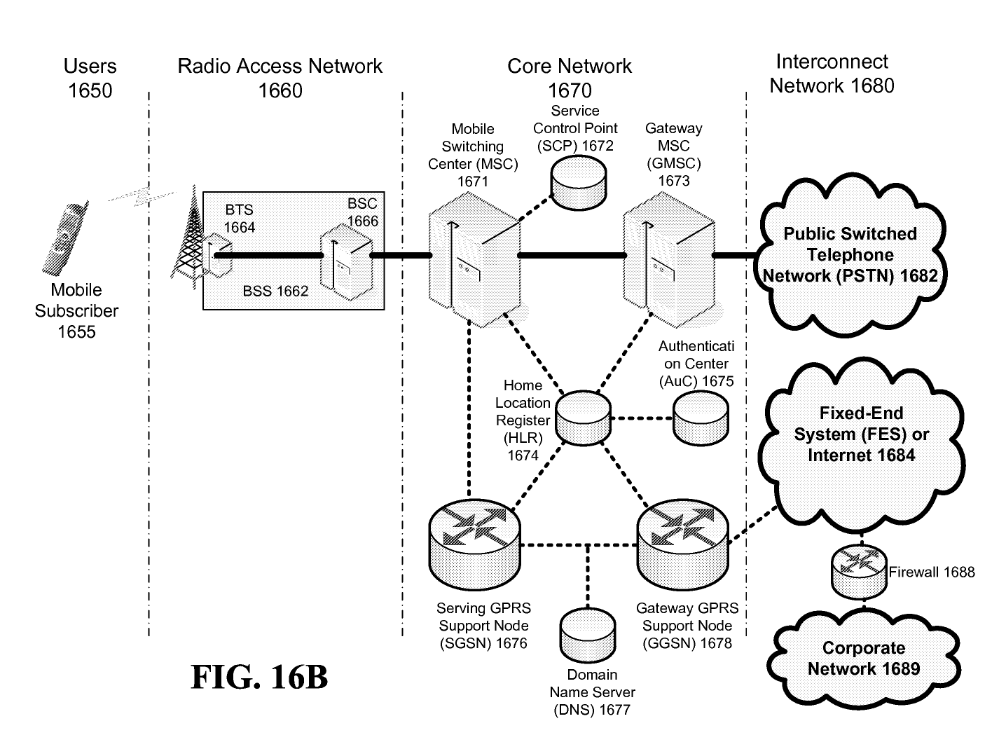

Turning now to FIGS. 16A-B, an overview of a network environment suitable for service by embodiments of the invention is illustrated. The above-described systems and methodologies for non-cooperative multi-user transmission may be applied to any network; however, the following description sets forth some exemplary telephony radio networks and non-limiting operating environments for the present invention. The below-described operating environments should be considered non-exhaustive, however, and thus the below-described network architecture is merely one network architecture into which the present invention may be incorporated. It is to be appreciated that the invention may be incorporated into any now existing or future alternative architectures for communication networks as well.

The global system for mobile communication (“GSM”) is one of the most widely utilized wireless access systems in today's fast growing communications systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1× Evolution Data Optimized (“EVDO”), Code Division Multiple Access-2000 (“cdma2000 3×”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the techniques of the invention may be applied independently of the method of data transport, and does not depend on any particular network architecture, or underlying protocols.

FIG. 16A depicts an overall block diagram of an exemplary packet-based mobile cellular network environment, such as a GPRS network, in which the invention may be practiced. In such an environment, there are a plurality of Base Station Subsystems (“BSS”) 1600 (only one is shown), each of which comprises a Base Station Controller (“BSC”) 1602 serving a plurality of Base Transceiver Stations (“BTS”) such as BTSs 1604, 1606, and 1608. BTSs 1604, 1606, 1608, etc., are the access points where users of packet-based mobile devices become connected to the wireless network. In exemplary fashion, the packet traffic originating from user devices is transported over the air interface to a BTS 1608, and from the BTS 1608 to the BSC 1602. Base station subsystems, such as BSS 1600, are a part of internal frame relay network 1610 that may include Service GPRS Support Nodes (“SGSN”) such as SGSN 1612 and 1614. Each SGSN is in turn connected to an internal packet network 1620 through which a SGSN 1612, 1614, etc. can route data packets to and from a plurality of gateway GPRS support nodes (GGSN) 1622, 1624, 1626, etc. As illustrated, SGSN 1614 and GGSNs 1622, 1624, and 1626 are part of internal packet network 1620. Gateway GPRS serving nodes 1622, 1624 and 1626 mainly provide an interface to external Internet Protocol (“IP”) networks such as Public Land Mobile Network (“PLMN”) 1645, corporate intranets 1640, or Fixed-End System (“FES”) or the public Internet 1630. As illustrated, subscriber corporate network 1640 may be connected to GGSN 1624 via firewall 1632; and PLMN 1645 is connected to GGSN 1624 via boarder gateway router 1634. The Remote Authentication Dial-In User Service (“RADIUS”) server 1642 may be used for caller authentication when a user of a mobile cellular device calls corporate network 1640.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

FIG. 16B illustrates the architecture of a typical GPRS network as segmented into four groups: users 1650, radio access network 1660, core network 1670, and interconnect network 1680. Users 1650 comprise a plurality of end users (though only mobile subscriber 1655 is shown in FIG. 16B). Radio access network 1660 comprises a plurality of base station subsystems such as BSSs 1662, which include BTSs 1664 and BSCs 1666. Core network 1670 comprises a host of various network elements. As illustrated here, core network 1670 may comprise Mobile Switching Center (“MSC”) 1671, Service Control Point (“SCP”) 1672, gateway MSC 1673, SGSN 1676, Home Location Register (“HLR”) 1674, Authentication Center (“AuC”) 1675, Domain Name Server (“DNS”) 1677, and GGSN 1678. Interconnect network 1680 also comprises a host of various networks and other network elements. As illustrated in FIG. 16B, interconnect network 1680 comprises Public Switched Telephone Network (“PSTN”) 1682, Fixed-End System (“FES”) or Internet 1684, firewall 1688, and Corporate Network 1689.

A mobile switching center can be connected to a large number of base station controllers. At MSC 1671, for instance, depending on the type of traffic, the traffic may be separated in that voice may be sent to Public Switched Telephone Network (“PSTN”) 1682 through Gateway MSC (“GMSC”) 1673, and/or data may be sent to SGSN 1676, which then sends the data traffic to GGSN 1678 for further forwarding.

When MSC 1671 receives call traffic, for example, from BSC 1666, it sends a query to a database hosted by SCP 1672. The SCP 1672 processes the request and issues a response to MSC 1671 so that it may continue call processing as appropriate.

The HLR 1674 is a centralized database for users to register to the GPRS network. HLR 1674 stores static information about the subscribers such as the International Mobile Subscriber Identity (“IMSI”), subscribed services, and a key for authenticating the subscriber. HLR 1674 also stores dynamic subscriber information such as the current location of the mobile subscriber. Associated with HLR 1674 is AuC 1675. AuC 1675 is a database that contains the algorithms for authenticating subscribers and includes the associated keys for encryption to safeguard the user input for authentication.

In the following, depending on context, the term “mobile subscriber” sometimes refers either to the end user or to the actual portable device used by an end user of the mobile cellular service. When a mobile subscriber turns on his or her mobile device, the mobile device goes through an attach process by which the mobile device attaches to an SGSN of the GPRS network. In FIG. 16B, when mobile subscriber 1655 initiates the attach process by turning on the network capabilities of the mobile device, an attach request is sent by mobile subscriber 1655 to SGSN 1676. The SGSN 1676 queries another SGSN, to which mobile subscriber 1655 was attached before, for the identity of mobile subscriber 1655. Upon receiving the identity of mobile subscriber 1655 from the other SGSN, SGSN 1676 requests more information from mobile subscriber 1655. This information is used to authenticate mobile subscriber 1655 to SGSN 1676 by HLR 1674. Once verified, SGSN 1676 sends a location update to HLR 1674 indicating the change of location to a new SGSN, in this case SGSN 1676. HLR 1674 notifies the old SGSN, to which mobile subscriber 1655 was attached before, to cancel the location process for mobile subscriber 1655. HLR 1674 then notifies SGSN 1676 that the location update has been performed. At this time, SGSN 1676 sends an Attach Accept message to mobile subscriber 1655, which in turn sends an Attach Complete message to SGSN 1676.

After attaching itself with the network, mobile subscriber 1655 then goes through the authentication process. In the authentication process, SGSN 1676 sends the authentication information to HLR 1674, which sends information back to SGSN 1676 based on the user profile that was part of the user's initial setup. The SGSN 1676 then sends a request for authentication and ciphering to mobile subscriber 1655. The mobile subscriber 1655 uses an algorithm to send the user identification (ID) and password to SGSN 1676. The SGSN 1676 uses the same algorithm and compares the result. If a match occurs, SGSN 1676 authenticates mobile subscriber 1655.

Next, the mobile subscriber 1655 establishes a user session with the destination network, corporate network 1689, by going through a Packet Data Protocol (“PDP”) activation process. Briefly, in the process, mobile subscriber 1655 requests access to the Access Point Name (“APN”), for example, UPS.com (e.g., which can be corporate network 1679) and SGSN 1676 receives the activation request from mobile subscriber 1655. SGSN 1676 then initiates a Domain Name Service (“DNS”) query to learn which GGSN node has access to the UPS.com APN. The DNS query is sent to the DNS server within the core network 1670, such as DNS 1677, which is provisioned to map to one or more GGSN nodes in the core network 1670. Based on the APN, the mapped GGSN 1678 can access the requested corporate network 1679. The SGSN 1676 then sends to GGSN 1678 a Create Packet Data Protocol (“PDP”) Context Request message that contains necessary information. The GGSN 1678 sends a Create PDP Context Response message to SGSN 1676, which then sends an Activate PDP Context Accept message to mobile subscriber 1655.

Once activated, data packets of the call made by mobile subscriber 1655 can then go through radio access network 1660, core network 1670, and interconnect network 1680, in particular fixed-end system or Internet 1684 and firewall 1688, to reach corporate network 1689.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A wireless communication system, comprising:
a plurality of users, each of the plurality of users having a channel feedback component that generates and transmits channel state information; and
a base station that transmits data on a downlink, the base station comprising a plurality of transmit antennas and a precoding component that receives the channel state information from the plurality of users and coordinates multi-user transmission of the data from the plurality of transmit antennas to at least two users based on the channel state information.

2. The system of claim 1, wherein the base station employs a scheduling algorithm to select a portion of the users for which the multi-user transmission will be conducted.

3. The system of claim 1, wherein the precoding component coordinates the multi-user transmission at least in part by selecting a beamforming weight for each of the at least two users from a beamforming weight table that corresponds to the channel state information received from each respective user and applying the beamforming weight selected for each user to data to be transmitted to each respective user.

4. The system of claim 1, wherein the channel state information generated and transmitted by the channel feedback component at each of the plurality of users includes information corresponding to a channel direction in a channel space for each respective user.

5. The system of claim 4, wherein the channel space for each respective user is partitioned into 2^{N} regions, where N is a number of bits allotted for channel state information for each respective user, and the channel state information generated and transmitted by the channel feedback component at each of the plurality of users includes an index of a region in the channel space for each respective user in which the channel direction of the user is located, the index comprising N bits.

6. The system of claim 5, the base station further comprising an adaptive control component that determines a quality threshold for the channel state information generated by a channel feedback component at each of the plurality of users and restricts the multi-user transmission to at least two users in the plurality of users from which channel state information having a quality that meets or exceeds the quality threshold is received.

7. The system of claim 6, wherein the quality threshold corresponds to a correlation between a quantized channel direction for each of the plurality of users generated by the channel feedback component at each respective user and a true channel direction for each respective user.

8. The system of claim 6, wherein the channel feedback component at each of the plurality of users transmits channel state information only when the channel state information has a quality that meets or exceeds the quality threshold.

9. The system of claim 6, wherein the base station performs a single-user transmission to transmit data from the plurality of transmit antennas to a user in the plurality of users when channel state information having a quality that meets or exceeds the quality threshold is received from none or one of the plurality of users.

10. The system of claim 6, wherein the adaptive control component selects a user from the plurality of users to provide channel state information and an indicator of whether the channel state information meets or exceeds the quality threshold and coordinates a single-user transmission from the plurality of transmit antennas to the selected user or restricts the multi-user transmission based at least in part on the channel state information and the indicator received from the selected user.

11. A packet-based mobile cellular network environment employing the system of claim 1.

12. A method of non-cooperative multi-user communication in a wireless communication system, comprising:
receiving channel information feedback from one or more users;
selecting one or more precoding weights for at least two users from which channel information feedback is received based at least in part on the channel information feedback received from each respective user; and
transmitting data to the at least two users from which channel information feedback is received simultaneously at least in part by applying the one or more precoding weights selected for each user to which data is to be transmitted to a portion of the data for transmission to each respective user.

13. The method of claim 12, wherein the receiving channel information feedback includes receiving information corresponding to a channel direction in a channel space from the one or more users.

14. The method of claim 13, wherein the information corresponding to the channel direction is an index of a region in the channel space that contains the channel direction.

15. The method of claim 12, wherein the receiving channel information feedback includes receiving channel information feedback from one or more users having a feedback quality that meets or exceeds a predetermined threshold.

16. The method of claim 15, further comprising selecting a portion of the users from which channel information feedback is received according to a scheduling algorithm, wherein the selecting one or more precoding weights includes selecting one or more precoding weights for each of the selected users and the transmitting data includes transmitting data to the selected users.

17. The method of claim 15, further comprising:
selecting a user for feedback; and
receiving channel information feedback from the selected user, the channel information feedback including an indicator bit that indicates whether the channel information feedback from the selected user meets or exceeds the predetermined threshold;
wherein the selecting one or more precoding weights includes selecting one or more precoding weights for at least two users from which channel information feedback is received based at least in part on the indicator bit from the selected user, and the transmitting data includes transmitting data to the at least two users from which channel information feedback is received simultaneously based at least in part on the indicator bit received from the selected user.

18. A computer readable medium comprising computer executable instructions for performing the method of claim 12.

19. A system that facilitates non-cooperative multi-user wireless communication, comprising:
means for receiving channel feedback from one or more users;
means for beamforming one or more signals containing data to be transmitted to some or all of the one or more users based at least in part on the channel feedback received from the one or more users; and
means for transmitting the beamformed signals to some or all of the one or more users simultaneously.

20. The system of claim 19, wherein each of the one or more users from which channel feedback is received by the means for receiving channel feedback has a feedback quality equal to or higher than a feedback quality threshold.
